(19) United States
(12) Patent Application Publication
(10) Pub. No.: US 2014/0045148 A1
(43) Pub. Date: Feb. 13, 2014

(54) Capacity Building System for Developing Visual-Spatial Construction Planning Ability, Capacity Building Method, Capacity Building Program and Recording Medium Thereof

(71) Applicant: Toru Ishiyama, Kanagawa (JP)

(72) Inventor: Toru Ishiyama, Kanagawa (JP)

(21) Appl. No.: 13/952,931

(22) Filed: Jul. 29, 2013

(30) Foreign Application Priority Data
Aug. 13, 2012 (JP) 2012-179519

(51) Int. Cl. G09B 11/00

(52) U.S. Cl. CPC G09B 11/00
USPC 434/85

(57) ABSTRACT

A capacity building system is for developing visual-spatial construction planning ability. An arithmetic section has a model image display unit displaying a model image to be copied and a model image reference, a model image marks-entering request unit requesting the learner to enter marks, a model image auxiliary line-entering request unit requesting the learner to enter vertical and horizontal auxiliary lines in the model image area, an exercise image auxiliary line-entering request unit requesting the learner to enter vertical and horizontal auxiliary lines in an exercise image area, an exercise image marks-entering request unit requesting the learner to enter marks on positions, in the exercise image area, corresponding to the marks of the model image, and an exercise image forming request unit requesting the learner to form the exercise image by connecting between the marks in the exercise image area.

### BACKGROUND OF THE INVENTION

1. Field of the Invention

The present invention relates to a capacity building system for developing visual-spatial construction planning ability that is common to, for example, a drawing ability of drawings or paintings, a visual-spatial memory ability, an manipulation ability of visual-spatial mental imagery, an explicit (symbolic, graphical, linguistic) classification/analysis ability of visual feature of a target, and a visual spatial perception/cognition ability. The present invention also relates to a capacity building method for developing the visual-spatial construction planning ability, to a capacity building program for developing the visual-spatial construction planning ability, and to a recording medium of the capacity building program.

2. Description of the Related Art

As existing drawing education approach to improve the drawing ability of drawings or paintings, there is a traditional artistic drawing method. According to this artistic drawing method, when painting, brief overview of general target placement and position relations is first drawn, and then inside and neighboring detailed parts are drawn.

However, this artistic drawing approach cannot be applicable to people who are extremely bad at drawing, generally called as “ones with poor artistic taste”. This is because it is difficult for such people to perform rudimentary and essential exercise, that is, to precisely express or reproduce a shape, a position relations, a placement, a distance and an angle of two-dimensional module such as a circle or a square or three-dimensional module such as a ball or a cube on a paper, even though they can recognize a target by converting its image.

There exists a highly advanced visual-spatial construction model on combination of simple geometric figures. For example, a simplified model obtained by visual-spatially categorizing the constitution ratio of parts of person is frequently taken on a sketch, a portrait and a primer of comics. Famous linear perspective method or three-dimensional stereoscopic method called as Peirce method can be classified in the same category as this highly advanced visual-spatial construction model. However, as aforementioned, the traditional highly advanced visual-spatial construction model is very difficult approach for the people who are extremely bad at drawing, generally called as “ones with poor artistic taste”, and are impossible to perform drawing of lower level geometrical figure or to reproduce easier “relative distance between points”. In the class of art and drawing, these visual-spatial construction models are introduced in practice as the basis of drawing, but although most of people can understand meaning of the spatial classification, the majority of them cannot reflect the understanding and cognition about the spatial classification to the actual drawing. That is, since the artistic drawing method requires considerably high sense and vague integrant such as sensitivity/talent and artistic taste, there exists limitation for a beginner.

A grid method (the lattice method) is a representative example of the methods of which the beginner who is bad at drawing can make drawing, and is utilized in the class of drawing worldwide (Albrecht Durer, “Measurement Theory”, 1525). A concrete approach example of this grid method is a method of (1) preparing a painting to be reproduced, (2) placing thereon a uniform lattice frame plotted on a clear acryl plate for example, and (3) comparing the painting of (1) with the lattice and connecting lines within each square of the lattice by using the grid lines of the lattice as ruler.

A drawing method proposed by Betty Edwards (Betty Edwards (translated by Koichi Kitamura) “Draw by Right Side of Brain”, Third Edition, Erte Publication, 2002) is one using neuroscience knowledge currently spreading over worldwide. The methodology in this literature of “Draw by Right Side of Brain” is grounded on partial knowledge of psychology and neuroscience on the basis of the grid method. For example, a dualistic segmentation is introduced in the drawing method such that creation of the right brain, sensitivity, image and tendency of intuitive function are considered as R-mode, and that logic of the left brain, language, thought, sign and tendency of analytic function are considered as L-mode. Then, the drawing is performed by the R-mode because it requires mainly the function of the right brain.

The above-mentioned grid method of “Measurement Theory” is well-known in the art for several hundred years, but it has an essential defect. That is, any drawing training using the grid method may not improve the drawing ability and thus no learning effects may be anticipated.

According to repeated investigations of the inventor of this application, a painting was precisely reproduced during using the grid method with lattice, but the painting even if it is simple painting with only outline was poorly reproduced in bad balance as well as that before trained during the grid method without lattice. In other words, the training using the grid method hardly educated the visual-spatial construction planning ability that is necessary for drawing resulting a poor learning effect. Also, the training using the grid method seems less expected for functional contribution possibility to an intellectual foundation. Anyway, because paintings can be finished in the class of drawing, such training using the grid method is widely used over from the elementary school to the university. However, from the original viewpoint of the learning effect for the student, such training with low learning effect and poor ability development is not educationally effective approach.

That is, the training using the grid method educates how to use effective “tool” but does not educate how to use of an effective “brain”, and thus there is poor possibilities in such training for intellectual improvement which is the main aim of the education. Therefore, such training using the grid method is not fundamental problem-solution approach for people who are extremely bad at drawing, generally called as “ones with poor artistic taste” and may be terminated as a mere drawing work because its intellectual contribution possibility of drawing is low.

In the literature of “Measurement Theory”, it is described that an effective factor therein may have a function of ability development over considerably wide domain. However, the knowledge used as the grounds of this description are doubtful when considered from modern neuroscience knowledge, and there are much prejudice and belief about a stereotypic image in a typical drawing, about drawing ability (in painting and art domain), and about the function. Sometimes, common belief for joining the right brain described in the literature of “Draw by Right Side of Brain” and the originality is heard, but reliable grounds thereof are not reported scientifically. The grounds and the reasoning may be confused due to ideas as series dichotomy between the two, in which “drawing”≈“sensitivity”≈a “originality”≈“right brain” and they are antithetical to the intelligence. Therefore, the drawing method described in the literature of “Draw by Right Side of Brain” cannot be adopted for the object of the invention to develop visual-spatial construction planning ability because there is poor academic reliability in the intellectual development by unit of drawing apart from an effect in the methodology about improvement of particular drawing ability.

### SUMMARY OF THE INVENTION

It is therefore an object of the present invention to provide a capacity building system for developing visual-spatial construction planning ability, a capacity building method, a capacity building program, and a recording medium of the program, whereby drawing ability can be improved even for people who are extremely bad at drawing, generally called as “ones with poor artistic taste”.

Another object of the present invention is to provide a capacity building system for developing visual-spatial construction planning ability, a capacity building method, a capacity building program, and a recording medium of the program, whereby it is possible to drastically enhance the ability of visual-spatial construction planning.

According to the present invention, a capacity building system for developing visual-spatial construction planning ability includes a display section capable of displaying a model image containing mainly oblique lines and non-right angle cross lines in a model image area and an exercise image formed by a learner in an exercise image area, respectively, an input section capable of inputting contents to be displayed on the display section, a memory section preliminarily storing a plurality of model images, and an arithmetic section electrically connected to the display section, the input section and the memory section. The arithmetic section has a model image display unit for displaying a model image to be copied and a model image reference of the model image to be copied, in the model image area of the display section, the model image and the model image reference being selected and read out from a plurality of model images stored in the memory section, a model image marks-entering request unit for requesting the learner to enter marks on edges, cross points, top points and/or positions with a large inclination of the model image displayed by the model image display unit, a model image auxiliary lines-entering request unit for requesting the learner to enter a plurality of vertical auxiliary lines and a plurality of horizontal auxiliary lines in the model image area so that each vertical auxiliary line and each horizontal auxiliary line pass through at least one mark entered by the learner, an exercise image auxiliary line-entering request unit for requesting the learner to enter a plurality of vertical auxiliary lines and a plurality of horizontal auxiliary lines in the exercise image area based upon an exercise image reference displayed in the exercise image area and provided with a scale size different from that of the model image reference, the plurality of vertical auxiliary lines and the plurality of horizontal auxiliary lines entered in the exercise image corresponding to the plurality of vertical auxiliary lines and the plurality of horizontal auxiliary lines of the model image, an exercise image marks-entering request unit for requesting the learner to enter marks on positions, in the exercise image area, corresponding to the marks of the model image, the positions being on the plurality of vertical auxiliary lines and the plurality of horizontal auxiliary lines in the exercise image area, entered by the learner, and an exercise image forming request unit for requesting the learner to form the exercise image by connecting between the marks in the exercise image area entered by the learner with lines.

At first, the learner is requested to enter marks on edges, cross points, top points and/or positions with a large inclination on the model image, to enter a plurality of vertical auxiliary lines and a plurality of horizontal auxiliary lines in the model image area so that each vertical auxiliary line and each horizontal auxiliary line pass through the entered mark, to enter a plurality of vertical auxiliary lines and a plurality of horizontal auxiliary lines in the exercise image area corresponding to the plurality of vertical auxiliary lines and the plurality of horizontal auxiliary lines of the model image, to enter marks on positions, in the exercise image area, corresponding to the marks of the model image on the entered plurality of vertical and horizontal auxiliary lines, and to form the exercise image by connecting between the entered marks in the entered exercise image area with lines. In this case, an image containing mainly oblique lines and non-right angle cross lines is used as for the model image, and the exercise image is formed depending upon an exercise image reference with a scale size different from that of the model image reference. By using such model image, conscious strategy or stratagem and explicit record or analysis are requested, and by adding intellectual mapping and categorizing to the learning process, ability development of more multiple and highly advanced intellectual ability are enabled.

The capacity building system according to the present invention theorizes and systematizes the stratagem how the position relations in the visual spatial information should be configured as a picture under perception and recognition thereof with high precision, based upon the knowledge of neuroscience, cognitive science and learning science. In order to express a visual perception target as a painting or a drawing, it is insufficient to have only a space cognition ability which can precisely grasp a target but it is necessary to have a visual spatial construction process or a premeditated stratagem for reproducing the visual perception target with high precision. This ability was named as a visual-spatial construction planning ability, and a training method of developing the visual-spatial construction planning ability for people who are bad at drawing was developed.

The conventional drawing ability was treated as an ideological and sensible ability such as sensitivity, talent and artistic taste. The originality of the present invention is found in that biological and neuroscientific evidence and mechanism are used for the first time, and that the elementary drawing education for the people who are extremely bad at drawing, generally called as “ones with poor artistic taste” is theorized and systematized to establish the training method.

Also, the method of the present invention, which is the explicit and strategy type education but is different from the conventional suggestive and drill type learning, is advantageously capable of explicitly learning the visual spatial categories such as difference or feature and regularity in the visual spatial target. Since it has been considered that it is difficult to intentionally train such visual analytical ability generally called as observation skills, no systematic method of learning the observation skills is established even in the field of science in which the observation skills is indispensable.

It is considered that the method of the present invention can be applied to not only the elementary education of artistic drawing but also the elementary visual spatial analytic learning in the field of science in which no systematic observation/sketching learning has been proposed. Also, it is considered that the method of the present invention is effective for the visual-spatial elementary education in the field in which understanding, configuration and operation of geometric figure or space structure such as mathematics and the engineering are required.

It is preferred that the exercise image auxiliary line-entering request unit includes a length determination request unit for requesting the learner to determine lengths of vertical and horizontal auxiliary lines based upon the exercise image reference and to enter at least one vertical auxiliary line and at least one horizontal auxiliary line, an outer frame-entering request unit for requesting the learner to enter an outer frame of the exercise image based upon the lengths determined, and an auxiliary lines-additionally entering request unit for requesting the learner to additionally enter vertical and horizontal auxiliary lines necessary within the outer frame entered.

It is also preferred that the arithmetic section further includes an error check unit for informing an occurrence of error when an error occurred in the vertical and horizontal auxiliary lines entered by the learner in the exercise image area is equal to or larger than a predetermined value.

It is further preferred that the model image reference is defined by a plurality of model image reference points and that the exercise image reference is defined by a plurality of exercise image reference points having a distance there between, which is different from that of the plurality of model image reference points.

It is still further preferred that the arithmetic section further comprises a scoring unit for detecting an error between the model image and the exercise image formed to score the exercise image.

It is further preferred that the scoring unit includes an error detection unit for superimposing the model image on the exercise image after adjusting the scale size of the model image with the exercise image reference, and for detecting a sum of distance differences between edges, cross points, top points or positions with a large inclination of the exercise image formed and corresponding edges, cross points, top points or positions with a large inclination of the model image superimposed.

According to the present invention, also, a capacity building method for developing visual-spatial construction planning ability by a computer which includes a display section capable of displaying a model image containing mainly oblique lines and non-right angle cross lines in a model image area and an exercise image formed by a learner in an exercise image area, respectively, an input section capable of inputting contents to be displayed on the display section, a memory section preliminarily storing a plurality of model images, and an arithmetic section electrically connected to the display section, the input section and the memory section is provided. The method includes a model image display step of displaying a model image to be copied and a model image reference of the model image to be copied, in the model image area of the display section, the model image and the model image reference being selected and read out from a plurality of model images stored in the memory section, a model image marks-entering request step of requesting the learner to enter marks on edges, cross points, top points and/or positions with a large inclination of the model image displayed by the model image display step, a model image auxiliary lines-entering request step of requesting the learner to enter a plurality of vertical auxiliary lines and a plurality of horizontal auxiliary lines in the model image area so that each vertical auxiliary line and each horizontal auxiliary line pass through at least one mark entered by the learner, an exercise image auxiliary line-entering request step of requesting the learner to enter a plurality of vertical auxiliary lines and a plurality of horizontal auxiliary lines in the exercise image area based upon an exercise image reference displayed in the exercise image area and provided with a scale size different from that of the model image reference, the plurality of vertical auxiliary lines and the plurality of horizontal auxiliary lines entered in the exercise image corresponding to the plurality of vertical auxiliary lines and the plurality of horizontal auxiliary lines of the model image, an exercise image marks-entering request step of requesting the learner to enter marks on positions, in the exercise image area, corresponding to the marks of the model image, the positions being on the plurality of vertical auxiliary lines and the plurality of horizontal auxiliary lines in the exercise image area, entered by the learner, and an exercise image forming request step of requesting the learner to form the exercise image by connecting between the marks in the exercise image area entered by the learner with lines.

It is preferred that the exercise image auxiliary line-entering request step includes a length determination request step of requesting the learner to determine lengths of vertical and horizontal auxiliary lines based upon the exercise image reference and to enter at least one vertical auxiliary line and at least one horizontal auxiliary line, an outer frame-entering request step of requesting the learner to enter an outer frame of the exercise image based upon the lengths determined, and an auxiliary lines-additionally entering request step of requesting the learner to additionally enter vertical and horizontal auxiliary lines necessary within the outer frame entered.

It is also preferred that the method further includes an error check step of informing an occurrence of error when an error occurred in the vertical and horizontal auxiliary lines entered by the learner in the exercise image area is equal to or larger than a predetermined value.

It is further preferred that the model image reference is defined by a plurality of model image reference points and that the exercise image reference is defined by a plurality of exercise image reference points having a distance there between, which is different from that of the plurality of model image reference points.

It is still further preferred that the method further includes a scoring step of detecting an error between the model image and the exercise image formed to score the exercise image.

It is further preferred that the scoring step includes an error detection step of superimposing the model image on the exercise image after adjusting the scale size of the model image with the exercise image reference, and of detecting a sum of distance differences between edges, cross points, top points or positions with a large inclination of the exercise image formed and corresponding edges, cross points, top points or positions with a large inclination of the model image superimposed.

According to the present invention, further, a capacity building program product for developing visual-spatial construction planning ability is provided. The program product is stored in a computer which includes a display section capable of displaying a model image containing mainly oblique lines and non-right angle cross lines in a model image area and an exercise image formed by a learner in an exercise image area, respectively, an input section capable of inputting contents to be displayed on the display section, a memory section preliminarily storing a plurality of model images, and an arithmetic section electrically connected to the display section, the input section and the memory section. The arithmetic section has a model image display unit for displaying a model image to be copied and a model image reference of the model image to be copied, in the model image area of the display section, the model image and the model image reference being selected and read out from a plurality of model images stored in the memory section, a model image marks-entering request unit for requesting the learner to enter marks on edges, cross points, top points and/or positions with a large inclination of the model image displayed by the model image display unit, a model image auxiliary lines-entering request unit for requesting the learner to enter a plurality of vertical auxiliary lines and a plurality of horizontal auxiliary lines in the model image area so that each vertical auxiliary line and each horizontal auxiliary line pass through at least one mark entered by the learner, an exercise image auxiliary line-entering request unit for requesting the learner to enter a plurality of vertical auxiliary lines and a plurality of horizontal auxiliary lines in the exercise image area based upon an exercise image reference displayed in the exercise image area and provided with a scale size different from that of the model image reference, the plurality of vertical auxiliary lines and the plurality of horizontal auxiliary lines entered in the exercise image corresponding to the plurality of vertical auxiliary lines and the plurality of horizontal auxiliary lines of the model image, an exercise image marks-entering request unit for requesting the learner to enter marks on positions, in the exercise image area, corresponding to the marks of the model image, the positions being on the plurality of vertical auxiliary lines and the plurality of horizontal auxiliary lines in the exercise image area, entered by the learner, and an exercise image forming request unit for requesting the learner to form the exercise image by connecting between the marks in the exercise image area entered by the learner with lines.

According to the present invention, still further, a computer readable recording medium in which a capacity building program for developing visual-spatial construction planning ability is stored is provided. The program is used in a computer which includes a display section capable of displaying a model image containing mainly oblique lines and non-right angle cross lines in a model image area and an exercise image formed by a learner in an exercise image area, respectively, an input section capable of inputting contents to be displayed on the display section, a memory section preliminarily storing a plurality of model images, and an arithmetic section electrically connected to the display section, the input section and the memory section. The arithmetic section has a model image display unit for displaying a model image to be copied and a model image reference of the model image to be copied, in the model image area of the display section, the model image and the model image reference being selected and read out from a plurality of model images stored in the memory section, a model image marks-entering request unit for requesting the learner to enter marks on edges, cross points, top points and/or positions with a large inclination of the model image displayed by the model image display unit, a model image auxiliary lines-entering request unit for requesting the learner to enter a plurality of vertical auxiliary lines and a plurality of horizontal auxiliary lines in the model image area so that each vertical auxiliary line and each horizontal auxiliary line pass through at least one mark entered by the learner, an exercise image auxiliary line-entering request unit for requesting the learner to enter a plurality of vertical auxiliary lines and a plurality of horizontal auxiliary lines in the exercise image area based upon an exercise image reference displayed in the exercise image area and provided with a scale size different from that of the model image reference, the plurality of vertical auxiliary lines and the plurality of horizontal auxiliary lines entered in the exercise image corresponding to the plurality of vertical auxiliary lines and the plurality of horizontal auxiliary lines of the model image, an exercise image marks-entering request unit for requesting the learner to enter marks on positions, in the exercise image area, corresponding to the marks of the model image, the positions being on the plurality of vertical auxiliary lines and the plurality of horizontal auxiliary lines in the exercise image area, entered by the learner, and an exercise image forming request unit for requesting the learner to form the exercise image by connecting between the marks in the exercise image area entered by the learner with lines.

Further objects and advantages of the present invention will be apparent from the following description of the preferred embodiments of the invention as illustrated in the accompanying drawings.

### BRIEF DESCRIPTION OF THE DRAWINGS

FIG. 1 is a view illustrating concept of a visual-spatial construction planning ability according to the present invention;

FIG. 2 is a view supplementing the concepts of the visual-spatial construction planning ability according to the present invention and the known space cognition ability;

FIG. 3 is a view supplementing the concepts of the visual-spatial construction planning ability according to the present invention and the known space cognition ability;

FIG. 4 is a view illustrating the concept of a visual-spatial construction planning ability according to the present invention;

FIG. 5 is a view illustrating the concept of a visual-spatial construction planning ability according to the present invention;

FIG. 6 is a block diagram schematically illustrating an electrical configuration of a computer that forms a capacity building system for developing visual-spatial construction planning ability as an embodiment according to the present invention;

FIG. 7a is a flow chart schematically illustrating a part of a program for a training mode process of the computer in the embodiment of FIG. 6;

FIG. 7b is a flow chart schematically illustrating a part of a program for a training mode process of the computer in the embodiment of FIG. 6;

FIG. 7c is a flow chart schematically illustrating a part of a program for a training mode process of the computer in the embodiment of FIG. 6;

FIG. 8 is a block diagram schematically illustrating a configuration of the capacity building system formed by executing programs shown in FIGS. 7a to 7c;

FIG. 9 is a view illustrating an example of indication contents of a display section configured by a touch panel-type display in the embodiment of FIG. 6;

FIG. 10a is a view illustrating indication contents and input contents of the display section and an input section respectively, configured by the touch panel-type display in the embodiment of FIG. 6;

FIG. 10b is a view illustrating indication contents and input contents of the display section and an input section respectively, configured by the touch panel-type display in the embodiment of FIG. 6;

FIG. 10c is a view illustrating indication contents and input contents of the display section and an input section respectively, configured by the touch panel-type display in the embodiment of FIG. 6;

FIG. 11 is a flow chart schematically illustrating a part of a program for an error check process in the halfway stage of the computer in the embodiment of FIG. 6;

FIG. 12 is a view illustrating a drag manipulation in a scoring mode in the embodiment of FIG. 6;

FIG. 13 is a view illustrating model images used in validation training;

FIG. 14 is a graph illustrating the result of the validation when no training was performed at all;

FIG. 15 is a graph illustrating the result of the validation when no training was performed at all;

FIG. 16 is a graph illustrating the result of the validation when no training was performed at all;

FIG. 17 is a graph illustrating the validation result of learning effect when a conventional training using the grid method was performed;

FIG. 18 is a graph illustrating the validation result of learning effect when the conventional training using the grid method was performed;

FIG. 19 is a graph illustrating the validation result of learning effect when the conventional training using the grid method was performed;

FIG. 20 is a graph illustrating the validation result of learning effect when a training using a capacity building system of the embodiment of FIG. 6 was performed;

FIG. 21 is a graph illustrating the validation result of learning effect when the training using the capacity building system of the embodiment of FIG. 6 was performed; and

FIG. 22 is a graph illustrating the validation result of learning effect when the training using the capacity building system of the embodiment of FIG. 6 was performed.

### DESCRIPTION OF THE PREFERRED EMBODIMENTS

The concept of a method of the capacity building system according to the present invention is first described.

The capacity building system for developing visual-spatial construction planning ability according to the present invention is formed by taking up “the visual-spatial construction planning ability” formulated by the inventor of this application as an ability approximate to a new intellectual item, and by systematizing a method for education and/or learning to enhance indexes of the intelligence test and to provide a learning system, as well as “spatial cognition ability”, “attention ability”, “working memory capacity”, “fluid intelligence” and “crystallized intelligence” which can be found in inspection items of the intelligence test.

It is of considerable significance that the method of the present invention is quite different from the existing training method for becoming good at drawing, which may lack in scientific reliability, consistency and validity, and the educational program for connecting the drawing ability with development of the right brain ability, which has no scientific foundation but has a lot of negative evidences. Since such training method and educational program for finishing only appearance will accomplish a purpose of improving a consequent drawing or painting although their contribution possibility to intelligence is extremely doubtful, many of existing studies and methodologies have been proposed. Contrary to this, according to the capacity building system of the present invention, the drawing is used only in the exercise as for means for improving the visual-spatial construction planning ability. According to the present invention, it is possible to expressly provide a learning effect objectively by digitizing (in mm unit or a pixel unit) a picture drawn as a recording and scoring target. Thus, it will be understood that the ability building method according to the present invention is to develop and examine ability scientifically and like as the intelligence test rather than the culture educational development of drawing ability.

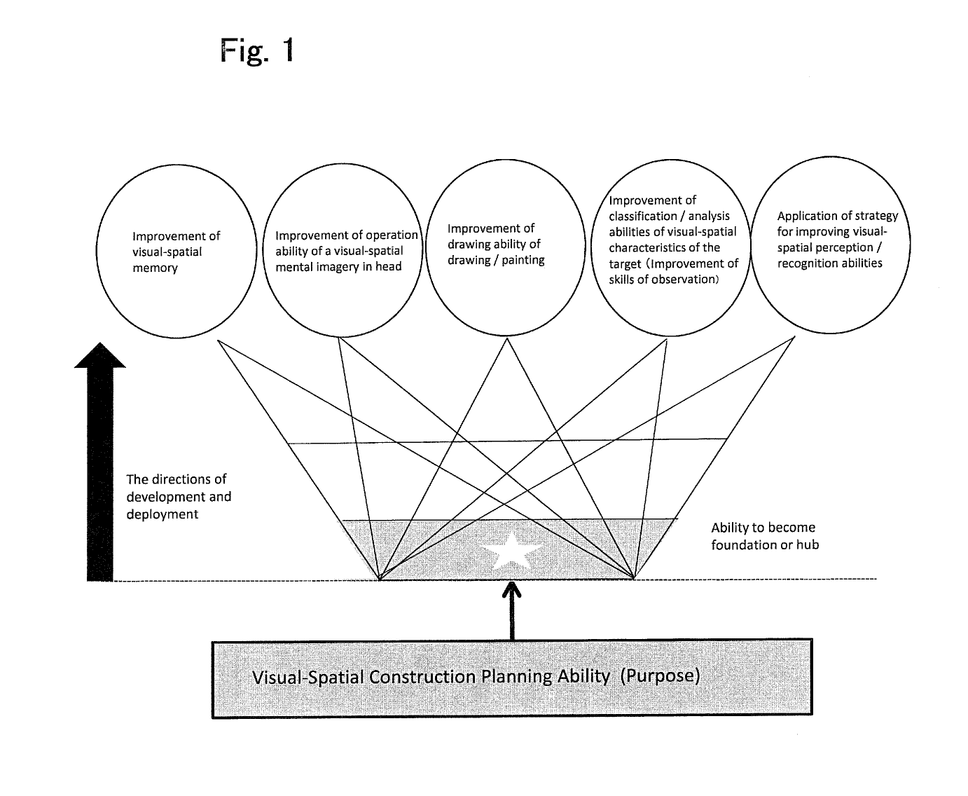

As shown in FIG. 1, the ability building method according to the present invention positions to improve “visual-spatial constitution plan ability” as an intellectual ability base which is common to various visual information processing ability and visual representation ability, such as drawing and visual-spatial memory, visual-spatial manipulation ability of mental imagery in head, drawing ability of drawing/painting, visual-spatial perception/cognition/memory abilities, and classification/mapping/analysis abilities of visual-spatial characteristics of the target. The visual-spatial constitution planning ability functions as base or hub common to these highly advanced intellectual ability.

There is a misleading similar name ability called as “space cognition ability”, but this ability is quite different from “visual-spatial constitution planning ability” in the method according to the present invention. From neuropsychological evidences, “space cognition ability” is the central function of parietal lobe which processes space information and somatic sensation and is one of fundamental abilities in the life activity, certainly provided in a high-order animal. Whereas “visual-spatial constitution planning ability” is more highly advanced and intellectual expression ability than “space cognition ability”, and is a high-order function that cannot be achieved without using functions of various domains of the brain, particularly function of the frontal lobe that is responsible for planning/executing/understanding/thinking, judging from a part of the name “construction planning”.

There are many intelligence tests for measuring the space cognition ability and many learning programs for obtaining a high score in the intelligence tests. Also, many of studies of the existing learning science and studies of cognitive science suggest the importance of the space cognition ability, and many studies mention relevance of the space cognition ability with the visual information processing and with the visual expression. Further, there are many researchers who point out a relationship between the space cognition ability and drawing ability. However, there is no reliable thesis showing a correlation between the space cognition ability and drawing ability, and there are many persons who have excellent space cognition ability but have poor drawing ability. The intelligence test of the space cognition ability for only perceiving/recognizing space information cannot measure intellectual activities such as more highly advanced explicit observation and analysis, identification of a common denominator and regularity, and extraction of the differences. The visual-spatial construction planning ability according to the present invention effectively functions to enhance the precision of the space cognition ability that is the biological basis and serves as an intermediary between this space cognition ability and the more highly advance intellectual activity. The method utilized in the capacity building system according to the present invention is configured based on biological mechanism and human cognitive mechanism from neuroscience or cognitive science, and is specialized for beginners to improve their visual-spatial construction planning ability, training of which has been quite difficult due to large differences among individuals.

The method of the present invention is a strategy type learning method that requires processes of initiative/plan/strategy but is not a drill type learning method of mere work.

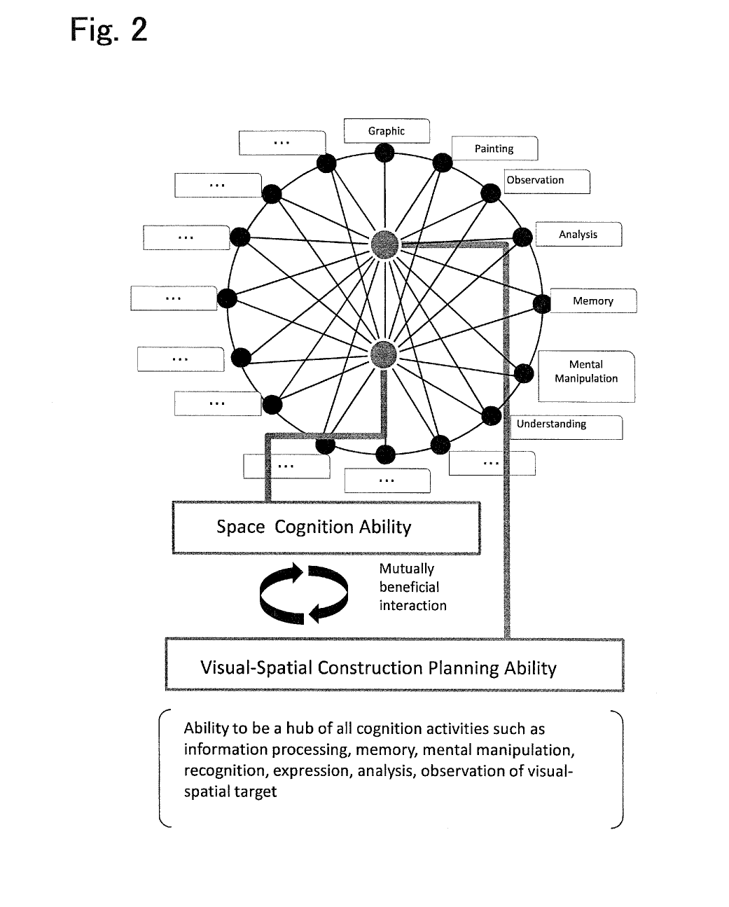

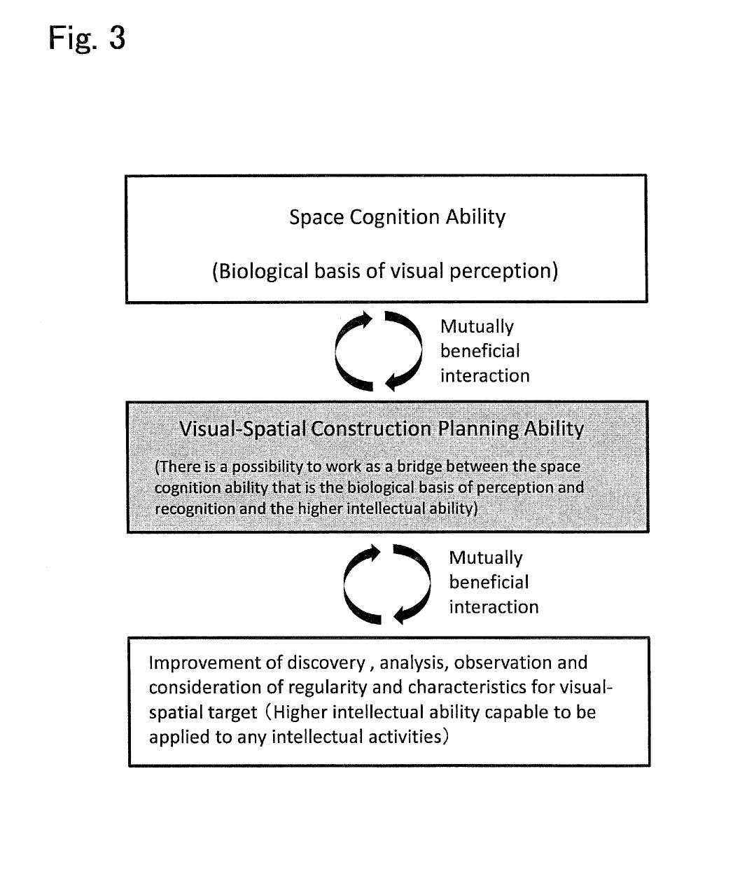

Heretofore described is positioning and scientific concept structure of the visual-spatial construction planning ability. FIGS. 2 and 3 show supplementary conception of the above-mentioned contents so as to allow visually understanding.

Hereinafter, brief summary of feature and device of a model image and an exercise image used in a training program to improve visual-spatial construction planning ability, according to the present invention will be described.

As aforementioned, the past study and education has hardly conducted development of the visual-spatial construction planning ability except for a training of the space cognition ability. For example, no concrete primary education focusing on categorization or mapping of visual spatial target is conducted in the drawing or art class in the elementary school, and also no concrete training is conducted in the science class, in the class of observation learning or observation sketching in the university. This fact is common on a global basis.

It is true that there are some persons who are provided with superior visual-spatial construction planning ability at the unconsciousness level and capable of intuitively perceiving the visual space feature without performing explicit verbalization and encoding, as well as that there are, at a constant rate, a few children who have excellent reflexes. These persons may advantageously understand, recognize and memorize such as architectural design, general design, art and geometry, recognition, and may easily learn a method that may be related to the visual-spatial construction planning ability for persons of intermediate level. This is similar that the children with excellent reflexes can bring out higher scores by learning a systematic running way although they are originally good runners.

The problem is that, as for the visual-spatial construction planning ability, not only there is no elementary education like reading/writing/calculation educations but also any hint of the elementary education is found. Thus, the drawing is caused by abstract factor such as perception, recognition, sensitivity, talent or feel, and the majority of people have not received elementary education for the systematic visual-spatial construction planning ability. This is to do a fractional calculation or a question of complicated geometry without learning addition and subtraction. Rarely existing is some people who can solve such question, but there is unreasonableness to be based on it and its educational validity is doubtful.

The method of the present invention specializes in a methodology in elementary education level of recognition/understanding/memory/analysis/classification of visual information, which makes full use of knowledge in neuroscience science, cognitive science, or educational science on the basis of biological mechanism. There was no concept of elementary education in the existing learning method relatively near to the method of the present invention because the educational subject matter was more specialized to the art.

The method of the present invention is summarized in clearly as a methodology whereby person who are extremely bad at drawing (with low ability in visual-spatial construction planning), generally called as “ones with poor artistic taste”, will be led to visual-spatially and scientifically correct understanding/analysis/expression of drawing by explicit and conscious training. Here again, the object of the method according to the present invention is not to improve the drawing ability of drawings or paintings although the method makes the learner draw drawings and scores the drawn drawings for digitizing as a tool.

This is similar to the mathematics or arithmetic that is learned not for a purpose of improving calculation speed and calculation accuracy as the drill learning, but learned for a purpose of developing logical thought or concept of number or quantity. The method according to the present invention, however, is a learning program for targeting ability development of more concrete explicit illustration, verbalization and encoding, which is more specific than achievement of the object of this mathematics or arithmetic.

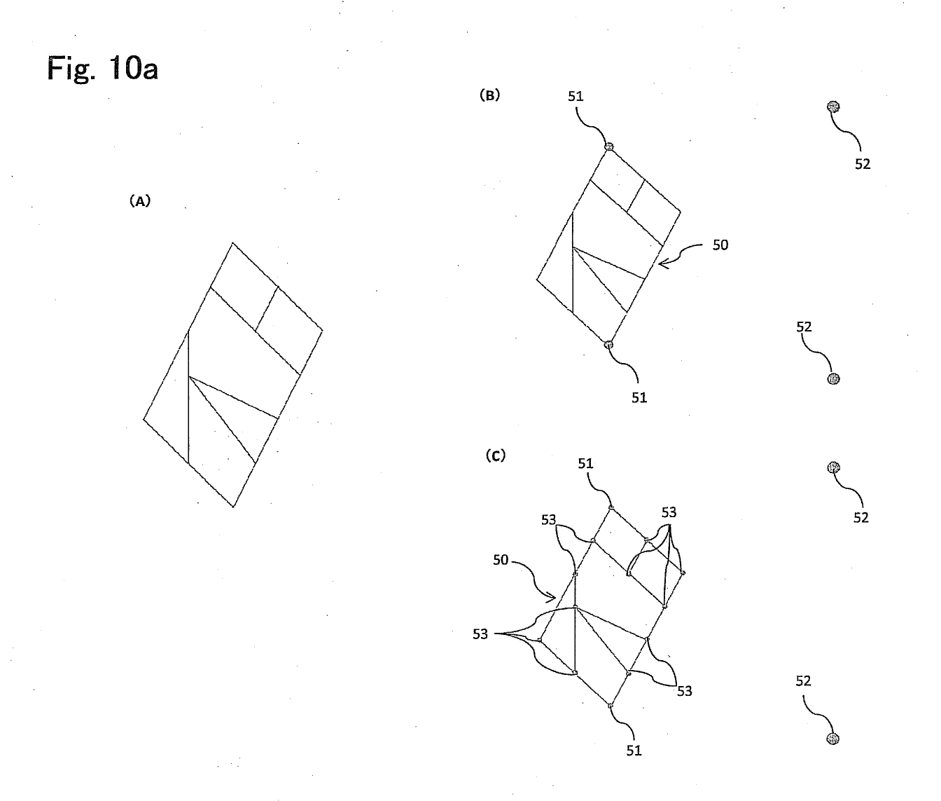

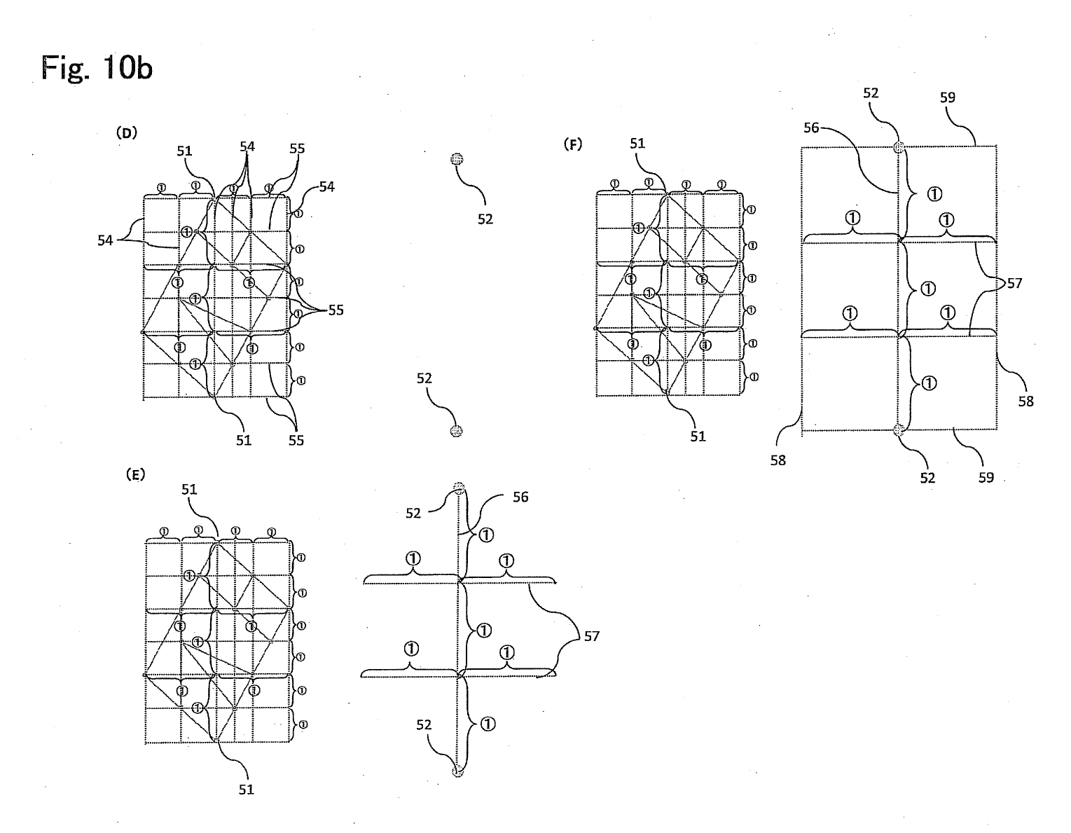

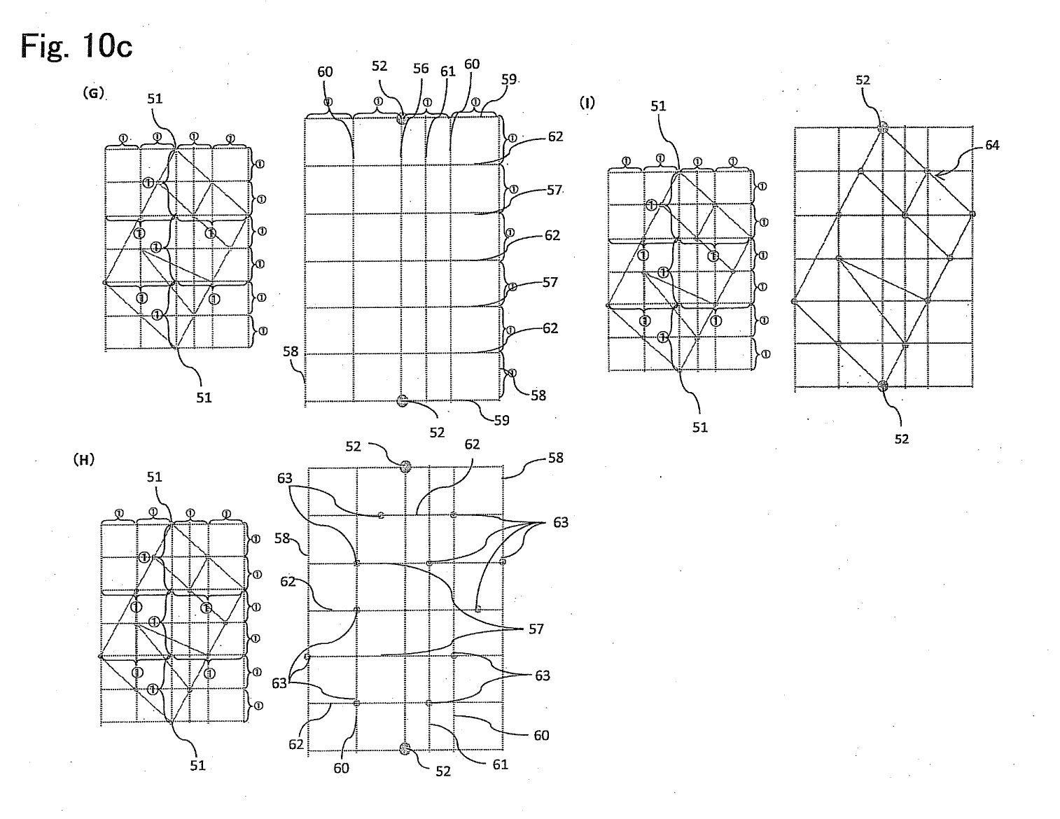

A model drawing (model image) used in a capacity building system according to the present invention is one with scientific evidence different from drawings used in the conventional drawing learning. In other words, the model image used herein is one, accurate copying of which is difficult with fuzzy recognition or perception, and which requires an elaborate visual-spatial construction plan. Besides, the model image used herein is a simple model image that requires no artistic professional drawing ability but is led from the scientific evidences. Therefore, as the model image, it is provided a geometric drawing or a simple drawing to which it is difficult to completely conform. FIG. 10 (A) shows an example of the model image. This drawing is appeared very simple and easy, but difficult for completely copying in actual. Thus, this drawing is effective for ability development of the visual-spatial construction planning ability, which is the target of the method according to the present invention.

By using such model image, conscious strategy or stratagem and explicit record or analysis are requested, and by adding intellectual mapping and categorizing to the learning process, ability development of more multiple and highly advanced intellectual ability are enabled.

Hereinafter, feature, artifice, screen configuration and tool of the capacity building system of the present invention, will be simply described.

As will be mentioned hereinafter, the inventor of the present invention has scientifically analyzed and compared learning effects about three groups consisting of (a) a method training group according to the present invention, (b) a traditional and sensuous grid method training group (drawing method of the mechanical drill type learning), and (c) a group conducting no training, in order to verify the learning effects of the capacity building system according to the present invention. The result thereof is that the method group according to the present invention (a) can provide a statistically meaningful difference to verify a learning effect, but that the grid method group (b) and the training-less group (c) can hardly provide any learning effect. Important is that the learning effect of the training-less group (c) which has not received any training and the learning effect of the grid method group (b) which has received training by drawing using a lattice exercise images depending upon a model image (model drawing) which is the same as that used in the training of the group (a) are substantially the same in result.

It should be noted that important is quality of learning such as what strategy or stratagem is used for the learning rather than a number and quantity of the problem in learning in order to obtain better learning effect. The method according to the present invention is a stratagem system for explicitly teaching by subdividing process of the problem into small steps using a drawing, a language and a sign concretely. The conventional methodology hardly satisfies the teaching conditions judging from the standard of the other lesson, and is vague, abstract, sensuous and ideological to miss the point. The reason of this may be because “drawing” has been tended to be expressed intelligently as a suggestive and native element such as sensitivity/talent/sense, but no educational program based on scientific mechanism has been built.

A learning program in the main five lessons in the elementary education is built so that a beginner such as a child can improve the learning by small step-up method. Even in lessons other than the main five lessons, many of the abstract, high repeatability, high reliability and high reasonability methods in the elementary education such as how to throw balls, how to run in sports or a lesson of piano are presented. Contrary to these lessons, with respect to “drawing”, there hardly exists “elementary education from 0 to 1” for beginner's level persons who are extremely bad at drawing, generally called as “ones with poor artistic taste”. In the higher level educations (the level higher than three or four phase in ten phases) of drawing, the learning programs have been presented. However, in the elementary education, because it is quite difficult verbalize or to systematize the act of drawing, no such learning program has been provided stating as it depends upon sensitivity, sense or heart.

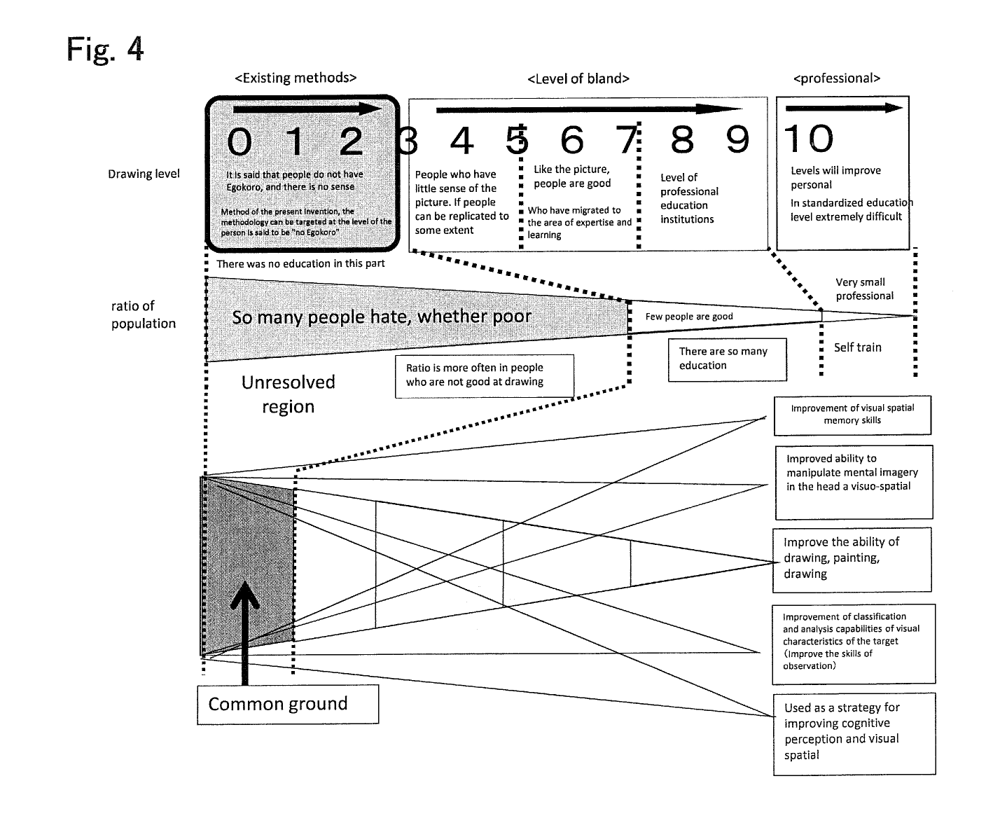

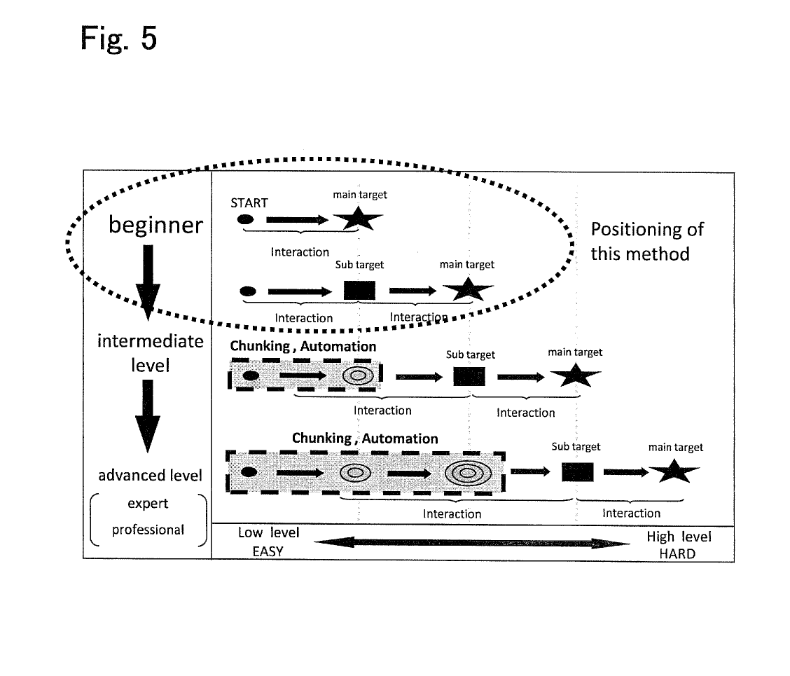

As shown in FIGS. 4 and 5, the method according to the present invention is a learning program of “visual-spatial construction planning ability” with an object for developing various abilities beyond the lessons, such as not only drawing ability but also ability of explicit observation learning and abilities of extraction, illustration, verbalization and encode of visual-spatial feature, regularity and law characteristics, as a matter of course ability having good connectivity with the method of drawing higher than the existing three phases levels. Therefore, a property of the method according to the present invention is considerably different from that of the methodology of the cultural/artistic drawing, and the drawing is conducted according to the present invention based upon scientific and mathematical analysis/consideration/planning. It is repeated that the object of the present invention is directed to improvement of the visual-spatial construction planning ability rather than the progress of painting/drawing.

The visual-spatial construction planning ability according to the present invention relates to analysis/thought/planning/initiative strategy systematized for making perception/recognition/understanding/memory a visual spatial target precisely, and is accomplished by performing a visual-spatial construction plan. In general, human visual perception/recognition/memory is surprisingly mysterious and weak, and thus, in order to precisely observe and analyze, it is necessary to get over various biological cognitive constraints. That is, the human being cannot store watched contents as it is in a brain as a camera. It is important how concentrate the attention on where of the target and whether it is possible to grasp or observe the target by packaging or mapping, and therefore learning of the systemized strategy is necessary to achieve the object.

A model is important in the learning as there is a common idea of “study is based upon imitation”. However, it is considered that there may be very few persons who have received explanation or logically and systematically studied demonstration with respect to the beginning class learning of drawing in the art class. In the educational guidelines, it is described that over concrete and logical guidance or explanation is unfavorable but personality of the child should be brought out. However, this approach has appearance of respecting personality but the individual difference is ignored. For example, there is no meaning to make calculation of fraction for child who cannot do addition. The education in Japan gives a bottom-up style education basically as an idea, but, with respect to drawing, neither the bottom-up style education nor a pull-up style education is performed. The completeness of the learning system in the drawing lesson seems to be lower than the other lesson.

The method according to the present invention is made by systemizing weak points of the conventional method to have a strategy which can be dealt with even by a beginner. The following (A) to (D) are feature points of the method according to the present invention.

(A) Demonstration images with detailed explanation about how to carry on drawing with respect to each problem are provided. The training is executed by subdividing the problem at every step (functions of understanding of intention and plan, sympathy, and mirror neuron).
(B) In accordance with a biological mechanism using a small step-up method, a focus of the attention is definitely guided by explanation of concrete illustration/language/sign, and learning is facilitated (attention, and activity and restraint of visual field).
(C) It is devised that setting of a visual spatial aim such as the main aim/second aim can be learned with good planning by using logically and scientifically systematized strategy/stratagem (interaction of frontal pole, prospective memory and contextual memory, interaction of the second aim and the main aim).
(D) A scoring system for digitizing a possible error of the drawing (mm unit, pixel unit) to objectively find where and how the error occurs is introduced, so that a level or feature of the learner can be easily known to clarify a remediation point.

Hereinafter, using an embodiment, a capacity building system for developing a visual-spatial construction planning ability according to the present invention will be described.

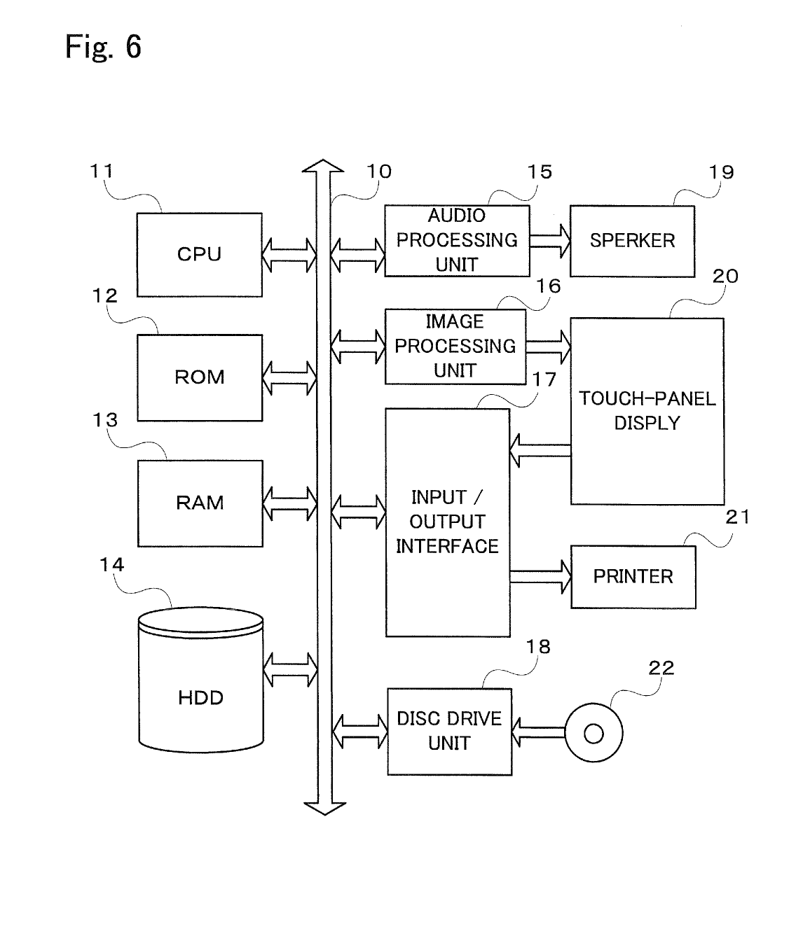

FIG. 6 schematically illustrates an electrical configuration of a computer that forms a capacity building system for developing visual-spatial construction planning ability as an embodiment according to the present invention.

As shown in the figure, the computer in this embodiment is constituted by a computer having a central processing unit (CPU) 11, a read only memory (ROM) 12, a random access memory (RAM) 13, a hard disk drive unit (HDD) 14, an audio processing unit 15, an image processing unit 16, an input/output interface 17, and a disc drive unit 18, connected with each other through a bus 10, and by a program for operating the computer.

The audio processing unit 15 is connected to a speaker 19, and the image processing unit 16 is connected to a touch-panel display 20. The touch-panel display 20 and a printer 21 are connected to the input/output interface 17. A blue-ray disc/a digital versatile disc/a compact disc (BR/DVD/CD) 22 can be put on the disc drive unit 18.

The CPU 11 performs processes of this embodiment by running programs stored in the RAM 13 in accordance with the basic programs of an operation system (OS) or the boot program stored in the ROM 12. Also, the CPU 11 controls operations of the RAM 13, the HDD 14, the audio processing unit 15, the image processing unit 16, the input/output interface 17 and the disc drive unit 18.

The RAM 13 is used as a main memory of the computer to store programs or data transferred from the HDD 14 and the disc drive unit 18. The RAM 13 is also used as a work area for temporarily storing various data when the program runs.

In the HDD 14, a program and data are preliminarily stored.

The audio processing unit 15 processes for playing various kinds of audio in response to instructions of the CPU 11 and outputs audio signals to the speaker 19.

The image processing unit 16 performs two-dimensional graphic processing in response to instructions of the CPU 11 to generate image data. The generated image data is output to the touch-panel display 20.

The input/output interface 17 controls data transferred between the touch-panel display 20 and the printer 21, and the CPU 11 or the RAM 13.

The disc drive unit 18 reads out a program or data from the set BR/DVD/CD 22 and transfers to the RAM 13 in response to instructions of the CPU 11. Also, the disc drive unit 18 may write a program or data into the set BR/DVD/CD 22.

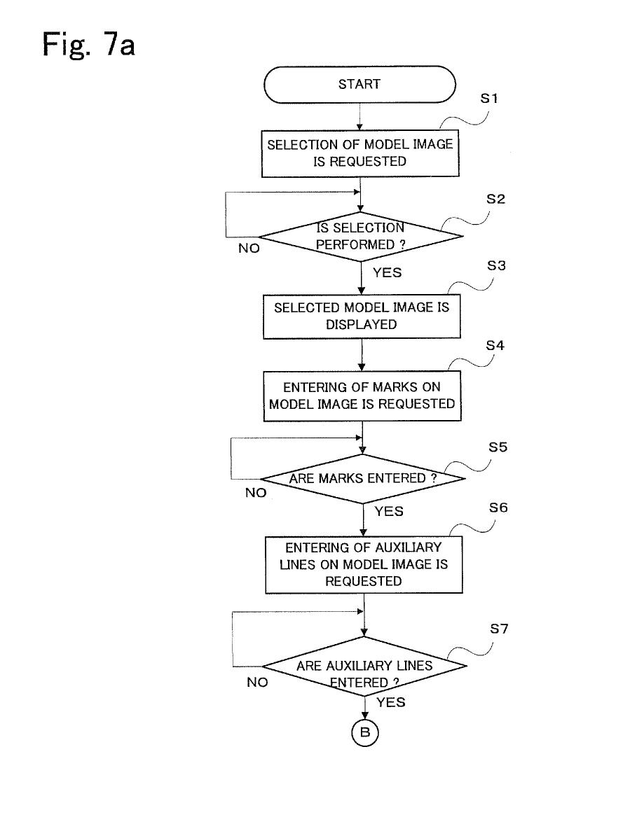

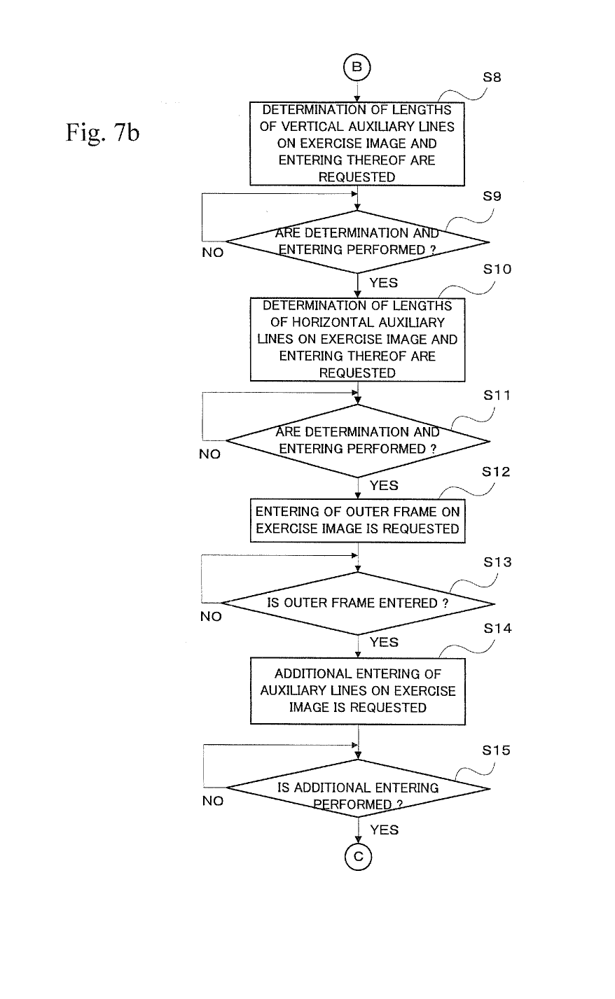

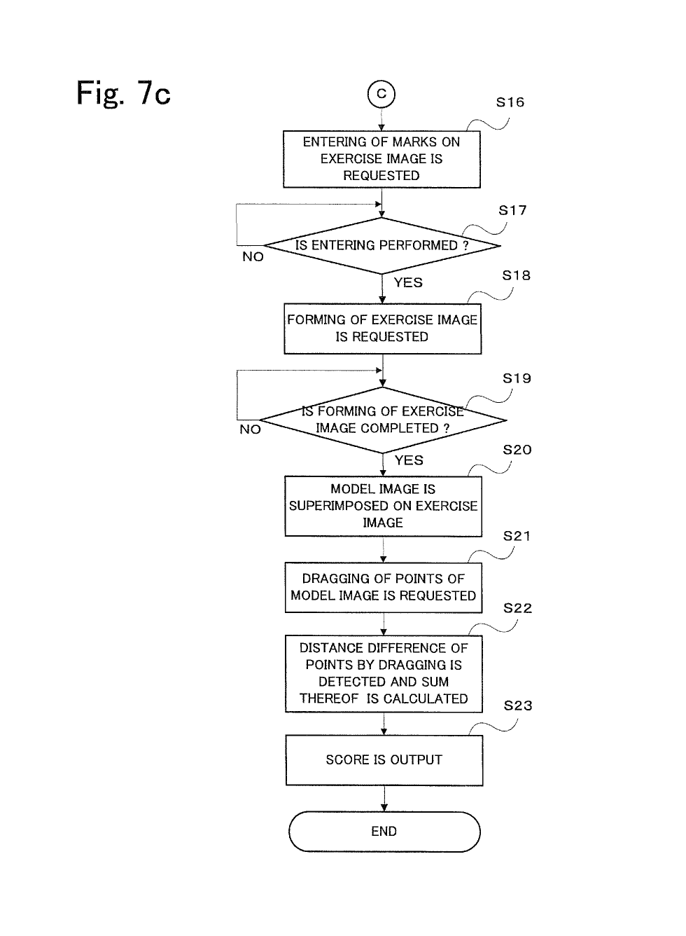

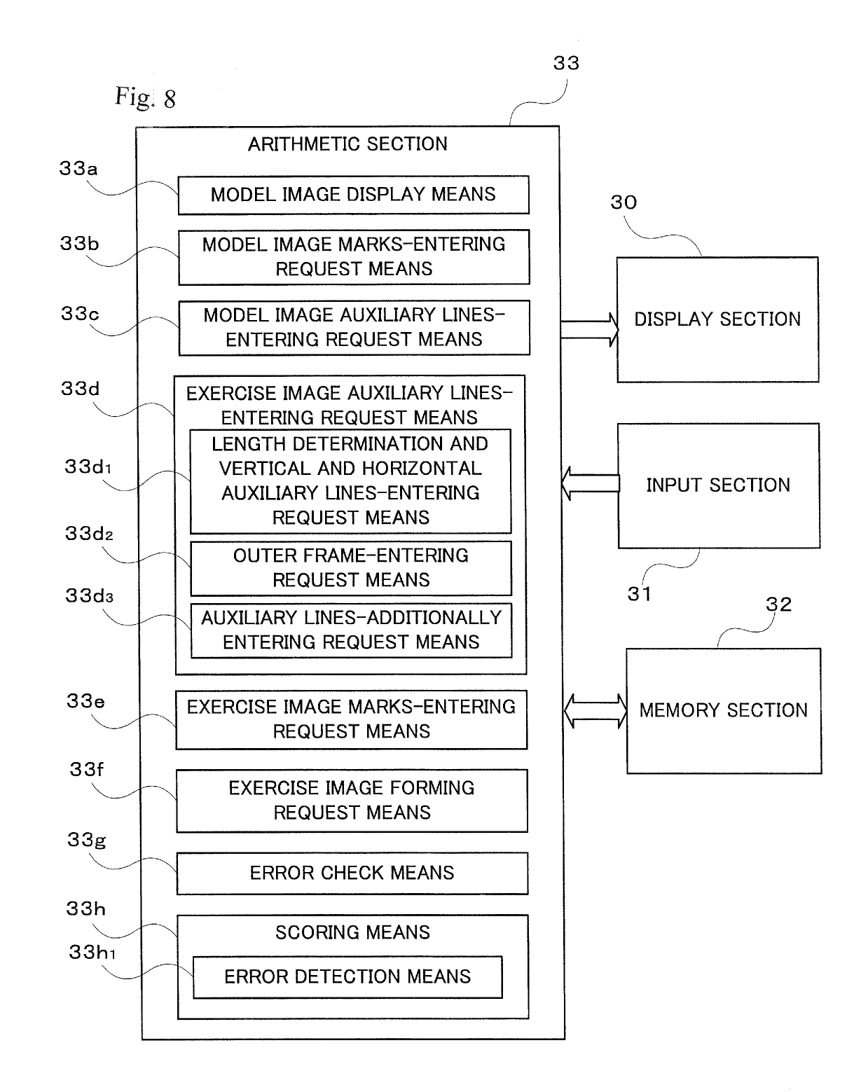

In the computer with such configuration, the CPU 11 in operation at first reserves a program memory area, a data storage area and a working area in the RAM 13, takes a program and data from the HDD 14 or the outside, and stores the program and the data into the program memory area and the data storage area. Then, based on the program stored in this program memory area, processes shown in FIGS. 7a to 7c are carried out. A capacity building system schematically illustrated in FIG. 8 is constructed by the CPU 11 executing the program shown in FIGS. 7a to 7c.

As shown in FIG. 8, the capacity building system of this embodiment includes a display section 30 and an input section 31 configured from the touch-panel display 20 and provided with a model image area on which display and input by a learner with respect to a model image are possible. The capacity building system of this embodiment also includes a memory section 32 configured from the RAM 13 and the HDD 14 for storing a plurality of model images and other data, and an arithmetic section 33 configured from the CPU 11.

The arithmetic section 33 includes a model image display means 33a, a model image mark-entering request means 33b, a model image auxiliary line-entering request means 33c, an exercise image auxiliary line-entering request means 33d, an exercise image mark-entering request means 33e, an exercise image forming request means 33f, an error check means 33g and a scoring means 33h.

The model image display means 33a is adapted to read out a model image to be reproduced, which was selected by a learner from a plurality of model images stored in the memory section 32 and model image reference points for this model image from the memory section 32, and to display on the model image area on the display section 30.

The model image mark-entering request means 33b is adapted to request the learner to enter marks onto cross-points (alternately, edges, apexes and/or largely inclined points in another embodiment) of the model image indicated by the model image display means 33a.

The model image auxiliary line-entering request means 33c is adapted to request the learner to enter a plurality of vertical auxiliary lines and a plurality of horizontal auxiliary lines so that each vertical auxiliary line and each horizontal auxiliary line pass through the plurality of cross-points entered by the learner.

The exercise image auxiliary line-entering request means 33d is adapted to request the learner to enter a plurality of vertical auxiliary lines and a plurality of horizontal auxiliary lines of the exercise image, which correspond to the plurality of vertical auxiliary lines and the plurality of horizontal auxiliary lines of the model image onto an exercise image area base upon exercise image reference points indicated in an exercise image area and provided with a different scale size from that of the model image reference points.

The exercise image mark-entering request means 33e is adapted to request the learner to enter marks at locations that correspond to the respective marks of the model image on the plurality of vertical auxiliary lines and the plurality of horizontal auxiliary lines of the exercise image, which lines are entered by the learner.

The exercise image forming request means 33f is adapted to request the learner to form an exercise image by entering lines for connecting the marks in the exercise image area, which marks are entered by the learner.

The error check means 33g is adapted to perform error check in response to a possible request of the learner and to inform occurring of an error when the checked error of the entered vertical auxiliary lines and horizontal auxiliary lines in the exercise image area is equal to or larger than a predetermined value.

The scoring means 33h is adapted to score by detecting an error between the formed exercise image and the model image.

The exercise image auxiliary line-entering request means 33d includes a length determination and vertical and horizontal auxiliary lines-entering request means 33d₁, an outer frame-entering request means 33d₂ and an auxiliary lines-additionally entering request means 33d₃.

The length determination and vertical and horizontal auxiliary lines-entering request means 33d₁ is adapted to request the learner to determine a length of the vertical auxiliary line and a length of the horizontal auxiliary line in accordance with the exercise image reference points, and to enter at least one vertical auxiliary line and at least one horizontal auxiliary line.

The outer frame-entering request means 33d₂ is adapted to request the learner to enter an outer frame of the exercise image based upon the lengths determined by the learner.

The auxiliary lines-additionally entering request means 33d₃ is adapted to request the learner to additionally enter a vertical auxiliary line and a horizontal auxiliary line that are necessary in the outer frame entered by the learner.

The scoring means 33h is adapted to have an error detection means 33h₁. The error detection means 33h₁ superimposes the model image by adjusting its scale size to the exercise image reference points and detects a sum of distance differences between cross-points in the formed exercise image (alternately, edges, apexes and/or largely inclined points in another embodiment) and corresponding cross-points in the superimposed model image (alternately, edges, apexes and/or largely inclined points in another embodiment).

Hereinafter, concrete processes of the capacity building system in this embodiment will be described in detail with reference to FIGS. 7a to 7c, FIG. 9 and FIGS. 10a to 10c.

When the capacity building system is activated, in practice, a test mode is carried out first, and then an original training mode is carried out. Because the test mode is provided to make a learner to be trained understand rough handling and operations of this capacity building system, which is a part of the training mode is simplified and omitted, no detailed description is performed here.

### Model Image Display Means

When the training mode is started, at first, selection of the model image is requested to a training learner (Step S1 in FIG. 7a). In the HDD 14 (corresponding to the memory section 32), a plurality of model images with various degrees of difficulty of the problem are stored. The learner selects one image from the plurality of model images depending upon difficulty levels indicated on the touch-panel display 20 (corresponding to the display section 30) by touching the touch-panel display 20 (also corresponding to the input section 31) with a stylus pen or a finger. Simultaneously, a problem condition depending on the difficulty level is selected. That is, setting of reference by points and selection of a difficulty level of the reference points are performed to select whether there is entering onto the model image or not.

The model image is an image mainly including oblique lines and cross-lines of non-right intersection angle. In this embodiment, it is determined that a model image shown in FIG. 10a (A) is selected. This model image is substantially formed by oblique lines, and intersection angle of the cross-lines is non-right (acute angle or obtuse angle but not right angle). Therefore, even if this model image is turned, all lines thereof never become vertical lines nor horizontal lines.

Scientific grounds of using such the model image are (1) oblique effect, and (2) perception/recognition of size, length, quantity, number, ratio and angle by means of parietal lobe.

(1) Oblique effect:

It is known that precision of perception/recognition/memory is lower in the oblique line than that of the vertical line and the horizontal line. This is a visuoperceptual law common to a biological base, seen commonly not only in a human being but also in a monkey and a cat from an electrophysiological experiment of neuroscience and fMRI (functional magnetic resonance imaging) experiment. Therefore, the model image almost constituted by oblique lines is used.

(2) Perception/recognition of size, length, quantity, number, ratio and angle by means of parietal lobe:

The three-dimensional visual spatial perception/recognition is carried out in parietal lobe. It is due to a neuronal function of CIP region in the intraparietal sulcus (rear portion of the outside wall of the intraparietal sulcus) that three-dimensionality such as perspective can be sensed even from a simple line drawing. It is considered that the function of the parietal lobe makes the core in painting, painting and drawing, and there have been a lot of case reports in which the position relations of the drawing break up by an obstacle of the parietal lobe and are impossible to sense.

Thereafter, it is judged whether the selection of the model image is performed (Step S2 of FIG. 7a). When the selection of the model image is accomplished (in case of YES) or when the learner clicks an icon of “NEXT” displayed on the touch-panel display 20, the selected model image 50 is displayed on the touch-panel display 20 (corresponding to the display section 30) (Step S3 of FIG. 7a).

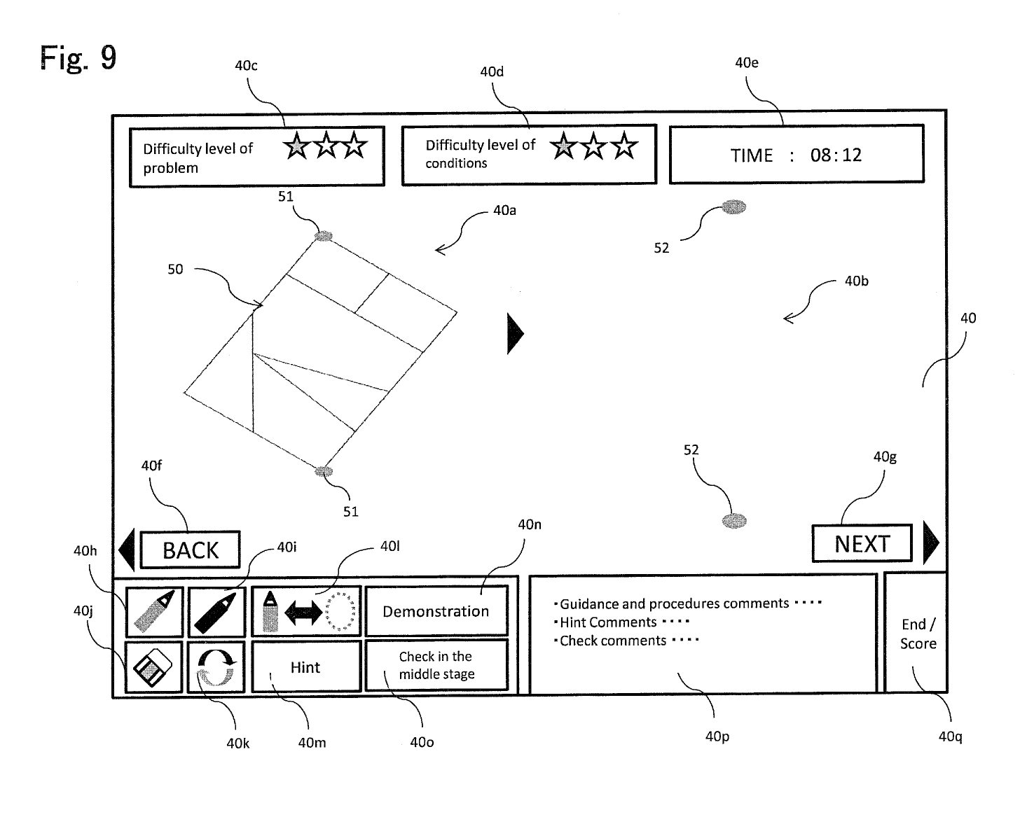

FIG. 9 shows an example of a screen of the touch-panel display 20 at the instant of this process. In the screen 40, a model image area 40a for indicating a model image 50, an exercise image area 40b for indicating an exercise image, a problem difficulty level area 40c for indicating a difficulty level of the problem or the model image, a condition difficulty level area 40d for indicating a difficulty level of problem conditions, a time display area 40e for indicating a time for addressing the problem, a BACK icon 40f, a NEXT icon 40g, an icon 40h of a pen (a plurality of colors) for drawing a mapping image, an icon 40i of a pen (black) for drawing an exercise image, an icon 40j of an eraser tool, an icon 40k of an image rotation tool, an icon 40ₗ for indicating/erasing the mapping image, a button 40m for requesting indication of hint/guidance, a button 40n for requesting indication of demonstration (motion picture) of series of drawing processes with respect to the problem, a button 40o for instructing partway error check, a comment display area 40p for indicating comments about guidance/procedure, comments about hint, and comments about the result of the partway error check, and an end/score button 40q for ending the problem/shifting to a scoring mode are displayed.

It should be noted that this training mode completely draws a drawing freehand, and therefore there is no graphic tool such as a straight line tool or a box tool at all. Thereby, it is possible to train in the same conditions as really drawing on a paper.

FIG. 10a (B) shows displayed images on the touch-panel display 20a at Step S3 of FIG. 7a, which indicates the selected model image 50. In the figure, only the model image area 40a and the exercise image area 40b are simply represented. Indications in the following FIG. 10a (C), FIG. 10b (D) to (F), and FIG. 10c (G) to (I) are similar to this.

In FIG. 10a (B), the model image area 40a is shown in the left side and the exercise image area 40b is shown in the right side. However, depending upon contents of the problem, the position of the model image area and the exercise image area may be changed in right and left or top and bottom (e.g., if it is a horizontally long model image, the model image area will be located top and the exercise image area will be located below the model image area). In the model image 50 and the exercise image, two reference points 51 of the model image 50 (model image reference points) and two reference points 52 of the exercise image 52 (exercise image reference points) are displayed as shown in FIG. 10a (B), respectively. Because the scale size of the model image 50 and that of the exercise image are different from each other, a distance between two reference points (model image reference points) 51 differs from a distance between two reference points (exercise reference points) 52. Since the scale size of the exercise image is different from that of the model image, a degree of difficulty of drawing the exercise image increases.

In case that a person who is bad at copying draws an exercise image based upon the model image at his choice, it will be often resulted to form too small image or too large image which never fits within the exercise image area. In contrast, if the reference points 51 and 52 are indicated as shown in FIG. 10a (B), a constant restriction occurs in the drawing space and thus guidance and advice of the learning procedure will go on smoothly. Such constant spatial restriction is necessary to enhance a learning effect.

Such spatial restriction of reference points has a plurality of styles and difficulty levels. Thus, by changing the restriction level, it is possible to change the difficulty level of copying even if the same drawing problem (model image) is used. In case that the scale size differs from that of the model image and thus the conditions change, it will be required to grasp spatial position relations of the whole and partial image (the reference points and parts derived from the reference points) and to perform the mapping. Thereby, it is possible to effectively learn the visual-spatial construction planning ability that is a highly advanced cognitive activity such as a visual spatial strategy or planning. Accordingly, it is understood that the capacity building system for developing the visual-spatial construction planning ability according to this embodiment is a visual spatial strategy type learning method in line with a natural view perception mechanism. The above-mentioned points is the decisive difference of the capacity building system of this embodiment with respect to the grid method that is a simple work drill type learning method (method of drawing and connecting discretely only parts).

The scientific grounds and cautions of using different scale sizes are (1) a perception/recognition of size, length, quantity, number, ratio and angle by means of parietal lobe, (2) a difficulty level depending upon the difference of scale sizes, and (3) a neural circuit of the brain of strategy type learning method.

(1) A perception/recognition of size, length, quantity, number, ratio and angle by means of parietal lobe: This is the same as aforementioned contents.
(2) A difficulty level depending upon the difference of scale sizes: The model image can be relatively easily copied to form an exercise image beside the model image by substantially grasping the length and the width of the model image if the scale size is the same. However, if the scale sizes are different between the model image and the exercise image, the difficulty level of the drawing becomes much higher than that when the scale sizes are the same. Therefore, various tools and methods for easily and mechanically enlarging a draft or rough image have been devised in the art history. The grid method has been utilized as an enlarging method of the draft or rough sketch.

Since the capacity building system for developing the visual-spatial construction planning ability according to this embodiment aims to develop the visual-spatial construction planning ability but not to improve drawing or graphic capability, the above-mentioned problem and method which are most appropriate for developing such ability are adopted.

(3) A neural circuit of the brain of strategy type learning method: According to the report of the OECD Center for Educational Research and Innovation (CERI), the strategy type learning method enables more correct understanding than the drill type learning method, so as to apply the understanding somewhere else. From this result, it is considered that the neural circuit of the drill type learning method is more inefficient than a neural circuit of the strategy type learning method. The fact that various neural circuits with different efficiencies are formed by the different teaching methods gives proof how the teaching method is important.

### Model Image Mark-Entering Request Means

When the model image 50 and the reference points 51 and 52 are indicated as shown in FIG. 10a (B), or when a learner clicks the NEXT icon 40g indicated on the touch-panel display 20, entering of marks on the model image 50 is requested to the learner (Step S4 of FIG. 7a).

Then, the learner enters marks 53 on cross points by touching, with a stylus pen or a finger, each cross point in the model image 50 indicated on the touch-panel display 20 (the display section 30).

Drawing into the exercise image area is not first begun but the visual spatial feature of the model image is analyzed/recorded and a mapping image is drawn (mapping of the model image is rehearsed). In this regard, at first small marks are drawn at “edges, cross points, apex points or points with rapidly changing inclination” of the figure or the model image. The mapping image (corresponding to a design drawing of the visual-spatial construction plan) is not described with a solid line (black) which is used for an exercise image but described using a mapping image tool (several colors including red). It should be noted that this mapping image can be deleted by using an icon 40l for mapping image indication/elimination before the final scoring stage so that the resulting figure can be easily read.

It is supposed in general that the human being watches a visual world well and memorizes it. However, in fact, the human being hardly looks a detailed portion of the visual world and never memorizes the detailed portion. That is, the human being watches with a high resolution only a specialized small portion to which his attention is attracted but watches with a lower resolution the peripheral portion thereof, so as to form an imagined visual world based upon these visual information using visual data memorized in the brain. Thus, important is how it is possible to instruct a learner to have an attention which is concrete and correct based upon an intention of the stratagem and its foregoing aim in order to make a precise copy in accordance with perception/recognition of the visual world of the human being. Even if it is instructed to watch well or to concentrate, most of the learners will vaguely look and thus it is extremely difficult to recognize/understand/analyze/memorize correct and precise visual-spatial information. There is a large difference between an accuracy or attention level in the visual perception and recognition of the everyday life and an accuracy or attention level required for correct observation. Therefore, this embodiment uses the small step-up method in which at every step specific and explicit, visual, linguistic and correct instruction is issued to concentrate attention on the necessary portion so as to grasp a strategy and an intention of the stratagem. As aforementioned, the capacity building system in the visual-spatial construction planning ability of this embodiment emphasizes a rehearsal of the mapping, and provides effective learning that enables assured step-up with a few mistake by teaching the rehearsal cautiously and carefully.

The scientific grounds and cautions in entering such marks are as follows: (1) textons, (2) change blindness and choice blindness (attention and consciousness/memory), (3) mental image and visual spatial working memory, and (4) attention and change of the brain activity.

(1) Textons: Julesz has reported, by generalizing knowledge of the perceptual psychology and the computational science, that it is possible to naturally see a color of line, a diameter of line, a direction of line, an edge of line and a cross point of lines as a partial factor (textons) which constitutes textures without paying attention.
(2) Change blindness and choice blindness (attention and consciousness/memory): Change blindness indicates that the human being is surprisingly insensitive to change in a visual target and teaches how it is difficult to watch the world well. A change in even the target selected himself may not be noticed (choice blindness).
(3) Mental image and visual spatial working memory: There may be impression that “image” can be freely drawn and memorized in the brain. However, scientifically, “image” is quite fuzzy, and it is known that the duration of “image” is short and that the quantity capable of memorizing “image” is little.
(4) Attention and change of the brain activity: Region of the brain corresponding to the space and the attribute attracting attention is activated but the activity of other region of the brain is restrained. Osaka et al. has clarified a series of mechanism through which consciousness of the top-down affects the visual attention function, from the record of the change in the brain activity using fMRI.

### Model Image Auxiliary Lines-Entering Request Means

Then, it is judged whether marks are entered or not (Step S5 of FIG. 7a). When the marks are entered (in case of YES) or when a learner clicks the NEXT icon 40g indicated on the touch-panel display 20, it is requested to enter auxiliary lines onto the model image 50 (Step S6 of FIG. 7a).

Thus, the learner enters a plurality of vertical auxiliary lines 54 and a plurality of horizontal auxiliary lines 55 using a stylus pen or a finger on the model image 50 indicated on the touch-panel display 20. In this case, as shown in FIG. 10b (D), it is entered that each vertical auxiliary line 54 and each horizontal auxiliary line 55 pass through at least one mark 53 already entered on the model image 50.

In the model image 50 of this embodiment, since the difficulty level is low and learning of stratagem is the target, each vertical auxiliary line 54 and each horizontal auxiliary line 55 pass through a plurality of marks 53. When the difficulty level increases, however, it may be impossible that each vertical auxiliary line 54 and each horizontal auxiliary line 55 completely pass through the plurality of marks 53. In that case, the vertical auxiliary line 54 and the horizontal auxiliary line 55 will be entered to pass through positions calculated from the average of two or more marks 53. Since it is used for assisting the drawing, the target of entering such the auxiliary lines will be achieved by providing functions of some hints for forming the drawing.

Then, lengths of sides of the illustrated mapping are compared and its ratio which is easy to be recognized such as 1:2 or 1:1 at 1:1:1 is recorded. There are plural patterns in mapping procedure. By recording the ratios in this way, to which attention should be paid in the top-down work during the later drawing in the exercise image area becomes clear and thus the precision of the drawing will be increased.

Why only vertical and horizontal mapping auxiliary lines are drawn has the following biological grounds. That is because an oblique line has poor precision in perception/recognition/memory in comparison with the vertical and horizontal lines and therefore it is inefficient in utilizing for the mapping auxiliary line. Also, if such oblique line is added to the image, the image becomes complicated causing rather inconvenient. Further, the vertical and horizontal lines can more precisely compare than the oblique line used for a triangle or a lozenge at the time of not only comparison/analysis of the length of the line (side) described later but also comparison/analysis of the quadrangular area. When the mapping to the model image is completed, a procedure to reproduce the similar mapping as the model image in the exercise image area is considered, and processes are imagined.

The scientific grounds and cautions in entering such auxiliary lines are as follows: (1) oblique effect, (2) perception/recognition of size, length, quantity, number, ratio and angle by means of parietal lobe, (3) parietal lobe, and calculation and arithmetic, (4) attention and change of the brain activity, and (5) retinal map and mental image.

(1) Oblique effect: This is the same as aforementioned contents.
(2) Perception/recognition of size, length, quantity, number, ratio and angle by means of parietal lobe: This is the same as aforementioned contents.
(3) Parietal lobe, and a calculation and arithmetic: It is intraparietal sulcus of parietal lobe to perform numerical processing.
(4) Attention and change of the brain activity: This is the same as aforementioned contents.
(5) Retinal map and mental image: The brain region corresponding to the image is activated without actual viewing (by drawing a mental picture of the image with closing the eyes). It is known that the shape of the image emerges in distribution of neuron activation of visual cortex in the same way. However, it is reported that an activity degree of visual cortex when actually viewed by eyes is generally larger and the image is clearer than these when imagined with closing eyes.

Exercise Image Auxiliary Lines-Entering Request Means (Determination of Lengths and Vertical and Horizontal Auxiliary Lines-Entering Request Means)

Then, it is judged whether vertical auxiliary lines and horizontal auxiliary lines are entered (Step S7 of FIG. 7a). When the vertical auxiliary lines and the horizontal auxiliary lines are entered (in case of YES) or when a learner clicks the NEXT icon 40g indicated on the touch-panel display 20, determination and entering of lengths of the auxiliary lines on the exercise image are requested (Step S8 of FIG. 7b).

Because the reference points 52 indicated in the exercise image area with respect to the reference points 51 indicated in the model image area of the touch-panel display 20 provide a known sole relative distance of the drawing, the learner reproduces the mapping image drawn in the model image area, based upon this relative distance. Concretely, at first, the reference points 52 of the exercise image area are connected by a vertical line 56. Since this embodiment adopts a simple model image, this vertical line just functions as the vertical auxiliary line 56.

It is important that the auxiliary line of the mapping is drawn in accordance with a strategy that considers the reference points beforehand. Because the main aim is to copy the drawing from only the reference points 52 in the exercise image area, it is important to set a sub aim in accordance with the main aim, that is, to form a mapping image configured only by the vertical lines and the horizontal lines. The visual spatial mapping of the drawing is first performed, what kind of procedure is appropriate for precisely drawing is analyzed, and then plan/strategy are devised. The stratagem procedure such as the setting of the sub aim (mapping of design drawing and the auxiliary line) in accordance with the main aim (drawing) is considered. These a series of visual spatial highly advanced cognitive activity corresponds to “visual-spatial construction planning ability”.

Then, it is judged whether the length of the vertical auxiliary line 56 connecting the reference points 52 is determined and entered (Step S9 of FIG. 7b). When the vertical auxiliary lines are entered (in case of YES) or when a learner clicks of the NEXT icon 40g indicated on the touch-panel display 20, determination of lengths of the horizontal auxiliary lines 57 on the exercise image and entering thereof are requested (Step S10 of FIG. 7b).

As shown in FIG. 10b (E), this determination process of the lengths of the horizontal auxiliary lines 57 is to calculate the length of the auxiliary lines 57 from a ratio using the length of the vertical auxiliary lines 56 drawn beforehand. Because taking of a ratio using two sides with a relative distance as short as possible will provide high precision drawing, in this example, the length of the right half of the horizontal auxiliary line 57 is determined to be equal to the length of one-third of the vertical auxiliary line 56, that is, the ratio thereof is determined to 1:1, and the horizontal auxiliary line 57 is drawn from the center to the right side and to the left side to have the same length with each other. It is important to draw using a line as short as possible, based upon a reference that is revealed as reliably correct. In case of a comparison of the length, the ratio may be measured using a pen and a finger. Using of quantitative tools such as a ruler is inhibited because it cannot increase the precision of the measurement with the eye. It is established from the comparison with the traditional grid method of the preliminary study that, when a tool such as a ruler is used, improved is only the method used for the tool but the method of effectively using the brain (learning effect of the visual-spatial construction planning ability) is not improved. As for the early training of the beginner, however, because the precision is low in simple visual measurement of the relative distance, measurement using tool, finger or hand may be of service of effective learning. Even when a professional painter intends to draw a landscape, a horizontal width or a vertical width of a building is matched to a distance between the tip of a pencil and the tip of his thumb, and then horizontal and vertical lengths of the town are measured using the distance as a reference. As for a figure painting, also, lengths of the human body other than a face are measured by the similar method using the horizontal and vertical lengths of the face as a reference. A complicated visual target may be enough and precisely grasped how a reference is substituted with a limited simple tool.

The scientific grounds and cautions in entering such vertical auxiliary lines and horizontal auxiliary lines on the exercise image are as follows: (1) oblique effect, (2) perception/recognition of size, length, quantity, number, ratio and angle by means of parietal lobe, (3) parietal lobe, and calculation and arithmetic, (4) attention and change of the brain activity, (5) retinal map and mental image, and (6) functions of frontal pole (AREA 10) which is a base of human intellect (interaction of the frontal pole, prospective memory and contextual memory, interaction of a second aim and the main aim).

(1) Oblique effect: This is the same as aforementioned contents.
(2) Perception/recognition of size, length, quantity, number, ratio and angle by means of parietal lobe: This is the same as aforementioned contents.
(3) Parietal lobe, and a calculation and arithmetic: This is the same as aforementioned contents.
(4) Attention and change of the brain activity: This is the same as aforementioned contents.
(5) Retinal map and mental image: This is the same as aforementioned contents.
(6) Functions of frontal pole (AREA 10) which is a base of human intellect (interaction of the frontal pole, prospective memory and contextual memory, interaction of a second aim and the main aim): Anterior pole frontal cortex is the brain region of which a human being is most developed among the animals. It was found from experiments that, as a characteristic function of the anterior pole frontal cortex, which is different from that of other prefrontal region, only the right and left anterior pole frontal cortexes are specifically activated when a problem with the main aim put in advance of some of the sub aims is performed with conscious of the main aim (in case that there is correlation between the main aim and the sub aims). It is considered that this function is necessary for carrying out a plan or a logic to be conscious of a precedent problem while accomplishing the current problem.

### Exercise Image Auxiliary Lines-Entering Request Means (Outer Frame Entering Request Means)

Then, it is judged whether the determination and entering of the length of the horizontal auxiliary lines 57 are performed (Step S11 of FIG. 7b). When the determination and entering of the horizontal auxiliary lines 57 are performed (in case of YES) or when the learner clicks the NEXT icon 40g indicated on the touch-panel display 20, entering of the outer frame onto the exercise image is requested (Step S12 of FIG. 7b).

After the determination and entering of the lengths of the vertical auxiliary lines 56 and the horizontal auxiliary lines 57, two vertical auxiliary lines 58 and two horizontal auxiliary lines 59 forming a rectangular shape, which constitute an outer frame of the mapping image, are pictured with paying attention so that these lines become parallel and perpendicular to a central base line. In this particular example, as shown in FIG. 10b (F), each of surfaces divided into six squares is compared with the corresponding portion in the left model image to confirm ratios of an angle, a length and an area.

Then, it is judged whether the vertical auxiliary lines 58 and the horizontal auxiliary lines 59 of the outer frame are entered (Step S13 of FIG. 7b). When the outer frame is entered (in case of YES) or when the learner clicks the NEXT icon 40g indicated on the touch-panel display 20, additional entering of next auxiliary lines is requested.

### Error Check Means

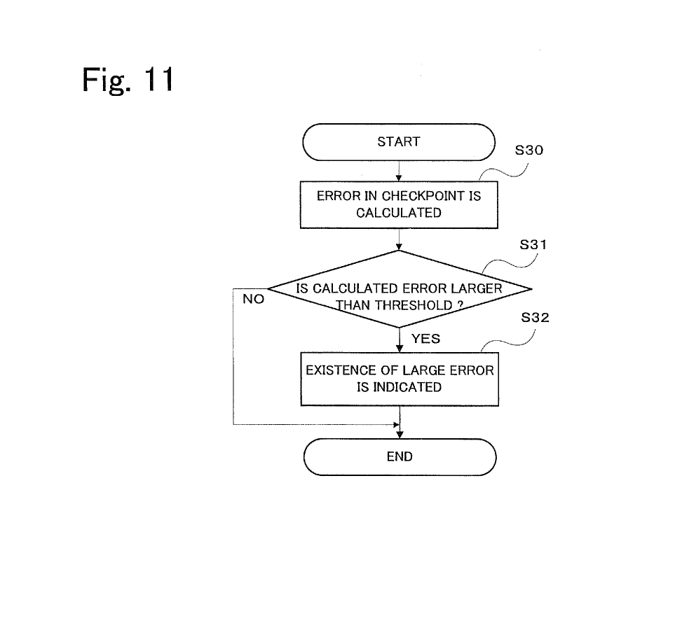

However, if a big error occurs at this stage concerning a basic plan, the occurred error grows bigger and bigger at the later steps causing the overall drawing to be modified. Therefore, it is desired to utilize functions of error check such that the learner clicks the button 40o indicated on the touch-panel display 20 for checking the error in the stage on the way of the mapping to point out possible occurrence of a big mistake. A processing routine shown in FIG. 11 corresponds to this error check in the stage on the way and starts by clicking the button 40o.

At first, an error in the checkpoint in the stage on the way is calculated (Step S30 of FIG. 11). Then, it is judged whether this calculated error is more than a relatively large threshold (Step S31 of FIG. 11). When it is judged that the calculated error is more than the threshold (in case of YES), a relatively rough indication (for example, an indication that an error is large at a portion of the top right corner in the case that the model image is equally divided into four portions) is provided on the touch-panel display 20 (Step S32 of FIG. 11). Here, it is configured that the learner looks for the error point. If the error point is preliminarily pointed out precisely, no learning effect may be provided. This is because the action of looking for the error itself is effective for developing the visual-spatial construction planning ability. More concretely, in the case that all of the checkpoints (points of intersections, edges, inclined points) of the model image are digitized along the X and Y axes in a program, if it is found that the exercise image entered by the learner has a large error with respect to the model image such that a certain checkpoint in the entered exercise image has a value of (X,Y)=(20,60) (millimeter unit or pixel unit) whereas the checkpoint in the model image is defined as (X,Y)=(18,25). If a large error is pointed out, the exercise image may be modified in accordance with it as a reference, the modification of the drawing can be effectively performed.

If it is judged at the Step S21 that the calculated error is equal to or less than the threshold value (in case of NO), no indication of error on the touch-panel display 20 is performed or no existence of error is indicated on the touch-panel display 20.

Such the error check in the stage on the way is not started only when the learner pushes the button 40o, but may be automatically started at an important timing on the way of the mapping. For example, when the NEXT icon 40g is clicked at the time of completion of the basics mapping which is the outline range of the drawing, a comment of the advice check in on the way may be forcibly generated.

If the precision check is performed after the vertical auxiliary lines and the horizontal auxiliary lines are drawn at a stroke on the exercise image area, the learning effect may be decreased. Thus, it is important that the procedure is subdivided into small steps as much as possible, and that at every completion of the small steps, the precision check of the visual space of the drawing is performed. This method will reduce occurrence of mistake, and occurred mistake can be easily corrected. Also, if too many operations are packed in only one step, the most of the operations may have to correct in some cases resulting the motivation of the learner to extremely lower. Such negative affections or feelings will remarkably reduce the learning effect.

The scientific grounds and cautions in entering such outer frame on the exercise image are as follows: (1) oblique effect, (2) perception/recognition of size, length, quantity, number, ratio and angle by means of parietal lobe, (3) parietal lobe, and calculation and arithmetic, (4) attention and change of the brain activity, and (5) learning and emotion, memory and emotion.

(1) Oblique effect: This is the same as aforementioned contents.
(2) Perception/recognition of size, length, quantity, number, ratio and angle by means of parietal lobe: This is the same as aforementioned contents.
(3) Parietal lobe, and a calculation and arithmetic: This is the same as aforementioned contents.
(4) Attention and change of the brain activity: This is the same as aforementioned contents.
(5) Learning and emotion, memory and emotion: Feelings and the emotion influence in learning greatly. Information accompanying positive affections or feelings can be effectively memorized, but information accompanying negative feelings is inefficient in memory. The memory in the brain will physically change as much as a neural network is anatomically formed therein, and thus will be a base of every human activities and intellectual activity such as learning or act/action/thought/plan. Therefore, important theme in education is how it is possible to learn with suppressing negative feelings.

Exercise Image Auxiliary Lines-Entering Request Means (Auxiliary Lines Additional Entering Request Means)

Then, additional entering of auxiliary lines on the exercise image is requested (Step S14 of FIG. 7b).

Thereby, the learner adds vertical auxiliary lines 60 and 61 and horizontal auxiliary lines 62 based on six squares divided by the vertical auxiliary lines 56 and 58 and the horizontal auxiliary lines 57 and 59 entered at Steps S8 to S13 of FIG. 7b as shown in FIG. 10c (G).

The approach of the basic mapping of the capacity building system for developing visual-spatial construction planning ability according to this embodiment uses stratagem based on biological mechanism to promote precisely and effectively the focus movement of viewpoint between the whole and the part by top-down concrete instructions. Therefore, the problem is shifted from “large (whole) to small (part)” slowly and each step performs the stratagem to raise the visual space precision. It is important that the mapping is performed with the procedure in which first the outer frame is entered and then the auxiliary lines are additionally entered. For example, with respect to a plurality of lines in the quadrangle of the mapping, if the drawing of the vertical line is started from the upper side in the quadrangle and the drawing of the horizontal line is started from the left side in the quadrangle, it is revealed from a preliminary study that the resulting drawing will have an extremely lower precision than that of the drawing using the method of the capacity building system according to this embodiment.

The reason of this is as follows. In order to perform the focus shift from the part to the whole, the mapping is completed within each of four divided squares according to the method of the capacity building system of this embodiment (in the case of this drawing), whereas the mapping is carried out in the most large quadrangle which is the outer frame of the mapping according to the aforementioned method of drawing the line sequentially from the left or the top.

In case of the capacity building system for developing the visual-spatial construction planning ability of this embodiment, the focus shift amount of part/whole is small and thus the relative distance can be more correctly grasped resulting that the precision rises. This is similar to the processes of Origami in which although it is difficult to longitudinally quarter the Origami based upon intuition without taking any procedure, it is more simple and rational processes to fold the Origami in half and then further fold it in half.

The scientific grounds and cautions in adding such vertical auxiliary lines and horizontal auxiliary lines on the exercise image are as follows: (1) perception/recognition of size, length, quantity, number, ratio and angle by means of parietal lobe, (2) parietal lobe, and calculation and arithmetic, (3) attention and change of the brain activity, (4) development of child brain and working memory, and (5) visual focus shift of whole and part.

(1) Perception/recognition of size, length, quantity, number, ratio and angle by means of parietal lobe: This is the same as aforementioned contents.
(2) Parietal lobe, and a calculation and arithmetic: This is the same as aforementioned contents.
(3) Attention and change of the brain activity: This is the same as aforementioned contents.
(4) Development of child brain and working memory: A working memory is a temporary memo pad of the brain, and is a memory for extremely short time work such as a temporary memory of mental arithmetic and phone number. Child has much individual difference in development of the brain, and the working memory of the child is smaller in capacity than that of adult. Thus, it is a key point for the learning of the child to perform the education of the high level intellect activity such as thought/plan without using a lot of capacity of the working memory.
(5) Visual focus shift of whole and part: Attention cannot devote to simultaneously both the whole and the part. When the whole/the part is focused, the active area in the brain changes. The capacity building system according to this embodiment is stratagem of the construction plan that can copy both the whole and the part of the drawing with a high precision.

### Exercise Image Marks-Entering Request Means

Then, it is judged whether an additional entering of the auxiliary lines is performed (Step S15 of FIG. 7b). When the additional entering of the auxiliary lines is performed (in case of YES) or when the learner clicks the NEXT icon 40g indicated on the touch-panel display 20, entering of marks onto the exercise image is requested (Step S16 of FIG. 7c).

Thereby, the learner enters points as marks also on the mapping image of the exercise image while comparing with the mapping image of the model image as shown in FIG. 10c (H). This work of the mark entering onto the exercise image may be unnecessary and additional entering of the auxiliary lines may be enough if the learner gets used to. However, since it is assumed that this is the first action of the beginner, a fine record of the mapping is registered to define a focus of the attention in the guidance and to lower the occurrence of error in the drawing as little as possible, so that the precision of the drawing in the next practice will be improved. Also, a chance of discovering mistake in the future can be increased by registering the record of the mapping as much as possible because error or mistake occurred at the stage on the way can be found.

The scientific grounds and cautions in entering such marks on the exercise image are as follows: (1) attention and change of the brain activity, and (2) development of child brain and working memory.

(1) Attention and change of the brain activity: This is the same as aforementioned contents.
(2) Development of child brain and working memory: This is the same as aforementioned contents.

Then, it is judged whether the entering of the marks is performed (Step S17 of FIG. 7c). When the entering is performed (in case of YES) or when the learner clicks the NEXT icon 40g indicated on the touch-panel display 20, forming of a final exercise image is requested (Step S18 of FIG. 7c).

In this case, because the final drawing rather than the mapping image is formed, the learner clicks the icon 40i of the black pen for making the exercise image on the touch-panel display 20, and the color of the drawing line is changed to black. Then, the learner connects by lines the marks on the auxiliary lines of the mapping with each other as shown in FIG. 10c (I). Thereafter, the learner performs a final check of the drawing, and if judged there is no problem, the learner will click the icon 40l for indicating/erasing the mapping image on the touch-panel display 20 to erase the red auxiliary lines. Then, there remains only the drawing of the black lines of the model image and the drawn exercise image. If the icon 40l is clicked once again, the mapping image that has been displayed will appear again.

### Scoring Means

Then, it is judged whether formation of the exercise image is completed (Step S19 of FIG. 7c). If the exercise image is already formed (in case of YES) or the learner clicks the end/score button 40q for shifting to end/scoring mode, the program is shifted to a scoring mode and the training program mode is finished.

By repeating such training, the learner can simplify the work of the fine mapping image with respect to the model image and can construct a mapping image with mental imagery in head. Thereby, the learner can begin direct drawing of the exercise image without entering any drawing in the model image area.

The capacity building system according to this embodiment also aims to extract feature, regularity and difference from the similar ones about visual information targets in the typical three-dimensional world, and to express the targets consciously, linguistically and symbolically. By accomplishing this aim, the visual-spatial construction planning ability can be developed over applications of much highly advanced intellectual activity not confined to drawing and graphic. The ability of the drawing will improve as its secondary effect.

As will be understood from the above-description, it is one aim of the present invention that the visual spatial mapping of the target can be precisely formed only with mental imagery in head. This ability will contribute to the intellectual base of general observation power, insight power and visual analytical ability.

The scientific grounds and cautions in performing such drawing are as follows: (1) retinal map and mental image, (2) functions of frontal pole (AREA 10) which is a base of human intellect (interaction of the frontal pole, prospective memory and contextual memory, interaction of a second aim and the main aim), and (3) long-term memory of the stratagem or automation by chunking.

(1) Retinal map and mental image: This is the same as aforementioned contents.
(2) Functions of frontal pole (AREA 10) which is a base of human intellect (interaction of the frontal pole, prospective memory and contextual memory, interaction of a second aim and the main aim): This is the same as aforementioned contents.
(3) Long-term memory of the stratagem or automation by chunking: Complicated recognition activity can be processed only in head without overflowing the capacity of the working memory if its content has been repeatedly learned or if some information is packaged to effectively memorize. This may correspond to for example a case wherein the calculation of numbers with a large number of figures is carried out by a mental arithmetic such as mental calculation using an abacus. It may be difficult to fulfill automation by chunking by merely repeating the complicated cognitive activity at random. Therefore, it is a point for effectively achieving the automation by chunking to learn in line with an easily understandable and simply systemized strategy or stratagem.

In the scoring mode, at first, the model image 50 of which reference points are adapted to that of the exercise image 64 by adjusting the scale size is superimposed on this exercise image 64 on the touch-panel display 20 as shown in FIG. 12 (Step S20 of FIG. 7c).

Then, dragging of scoring points P1-P11 of the model image 50 to corresponding scoring points P1′-P11′ of the exercise image 64, respectively, is requested to the learner (Step S21 of FIG. 7c). As for the scoring points, intersection points are used in this embodiment, but in alternations, edges of the image, top points of the image or positions with a large inclination may be used.

Due to this dragging, a distance difference (error) of each scoring point is detected, for example, by P1(x, y)−P1′(x′, y′), and a sum of the errors is calculated (Step S22 of FIG. 7c).

Thereafter, the scoring result is output (Step S23 of FIG. 7c). As the scoring result, the sum of the errors may be just output, or ranking or evaluation may be conducted depending upon the sum. This scoring result is stored for every learner with the date and time, the number of learning and the model image information in the HDD 14, and output to and printed by the printer 21 when requested.

Hereinafter, the validation result of the learning effect of the capacity building system according to this embodiment will be described.

The validation was carried out for thirty six human subjects of university students at 18-23 years old (university students in general humanities course but not in the art course nor in the design course). The subjects were divided into the following three groups each having twelve subjects:

(a) a group which did not train at all but examined the habituation and the exercise effect of digitized problem of the copying and the drawing,
(b) a group which trained by the grid method used in existing art education (drawing method of the mechanical drill type learning), and
(c) a group which trained using the capacity building system according to this embodiment.

Before beginning the training for validation, a pre-training test for drawing the digitized model image (test for copying only the outline of a sample model image) was performed for all the members of the three groups. Then, an experiment training was performed for the members in the training groups (b) and (c) for five days, in total for ten hours for two hours a day, in which approximate explanation of the program and the drawing stratagem explanation were about two hours (no break time was contained in the experiment training time). After the experiment training, a post-training test was performed for all the members of the three groups, and an effect of the experiment training was validated. A series of the pre-training digitized model test and the post-training digitized model test (two-days) and the experiment training (five-days) was carried all out within ten days. During the pre-training test and the post-training test, just copy was performed under the state where no entering is possible onto the sample model image.

The experiment training was conducted mainly on copying of the line drawing of the sample model image. The sample model image used was a model image not similar to the digitized model image used in the pre-training test and the post-training test or a model image of combination of simple figures. This is because if the training is executed by using a model image similar to the digitized model image used in the tests, there may be possibility of the improvement due to the habituation and the learning, resulting that no effectiveness of the method according to this embodiment can be alleged. In other words, it is necessary to learn with a training model image different from the digitized model image used in the tests in order to know whether the visual-spatial construction planning ability which is applicable to any kind of problems is realized.

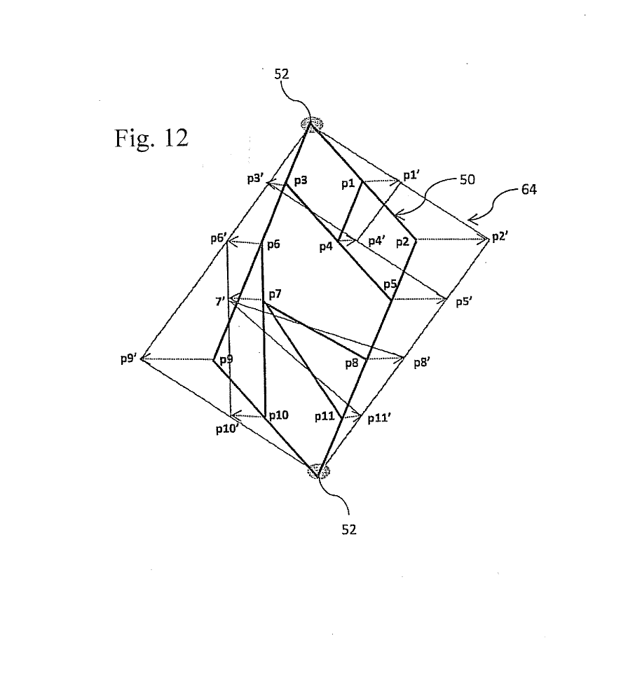

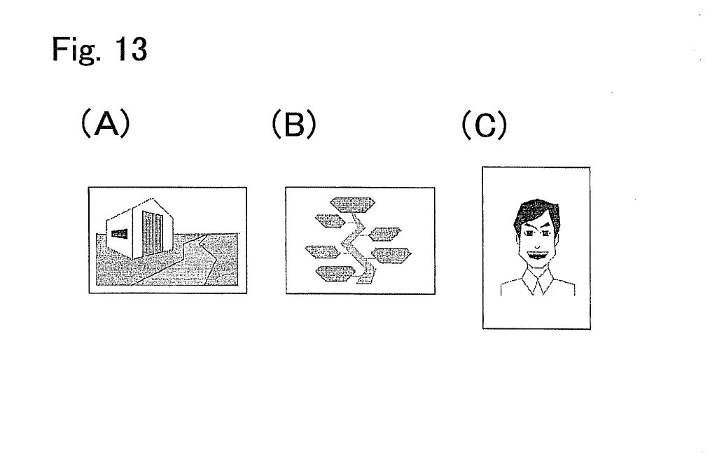

Concretely, in the tests, three kinds of different model image as shown in FIG. 13 were used to make a drawing. As a right and left asymmetry model image, “land scape” shown in FIG. 13 (A) and “pine tree” shown in FIG. 13 (B) were used, and as a right and left symmetry model image, “person” which is an upper body, shown in FIG. 13 (C) was used. Only profile lines of these model images were drawn. X and Y coordinates (mm) of the basic points (corners, edges and cross points) of inclination of lines in each drawing made in the tests were measured to digitize the drawing, so that the learning effect of each group was examined depending upon changes between the pre-training test and the post-training test. The degree of difficulty of the model images can be estimated from the number of the digitizing points and difficulty in determining the basic points to some extent. From our study of the test result of the subjects, the difficulty level of copy is in the order of “land scape”<“pine tree”<“person”. This because, if the number of the basic points on the lines increases, the gap in point and the distortion of lines will greatly affect the position relationship of the future picture and thus more correct and exact visual-spatial construction planning ability will be necessary.

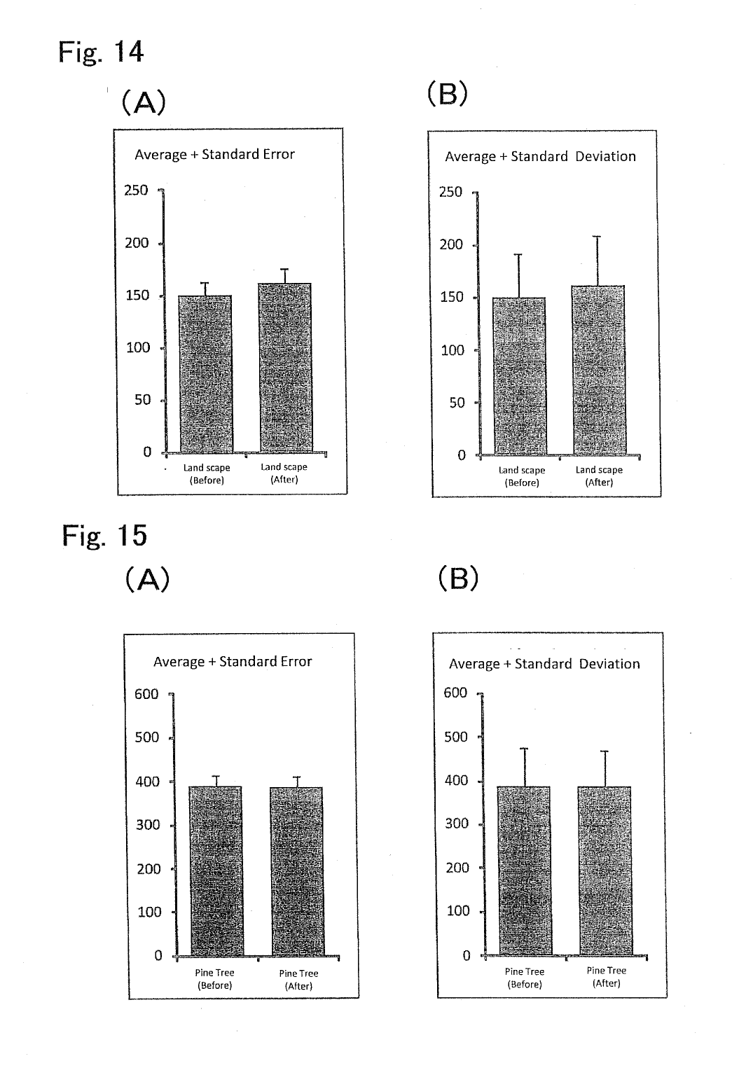

The scoring result of the pre-training test and the post-training test with respect to the model image of “land scape” in the group (a) which did not perform training at all is shown in FIG. 14. FIG. 14 (A) shows an average and a standard error, wherein the average before the training was 150.250, the standard error before the training was 11.980, the average after the training was 162.000, and the standard error after the training was 13.476. FIG. 14 (B) shows the average and a standard deviation, wherein the average before the training was 150.250, the standard deviation before the training was 41.499, the average after the training was 162.000, and the standard deviation after the training was 46.683.

The scoring result of the pre-training test and the post-training test with respect to the model image of “pine tree” in the group (a) which did not perform training at all is shown in FIG. 15. FIG. 15 (A) shows an average and a standard error, wherein the average before the training was 388.917, the standard error before the training was 25.101, the average after the training was 388.000, and the standard error after the training was 23.038. FIG. 15 (B) shows the average and a standard deviation, wherein the average before the training was 388.917, the standard deviation before the training was 86.952, the average after the training was 388.000, and the standard deviation after the training was 79.804.

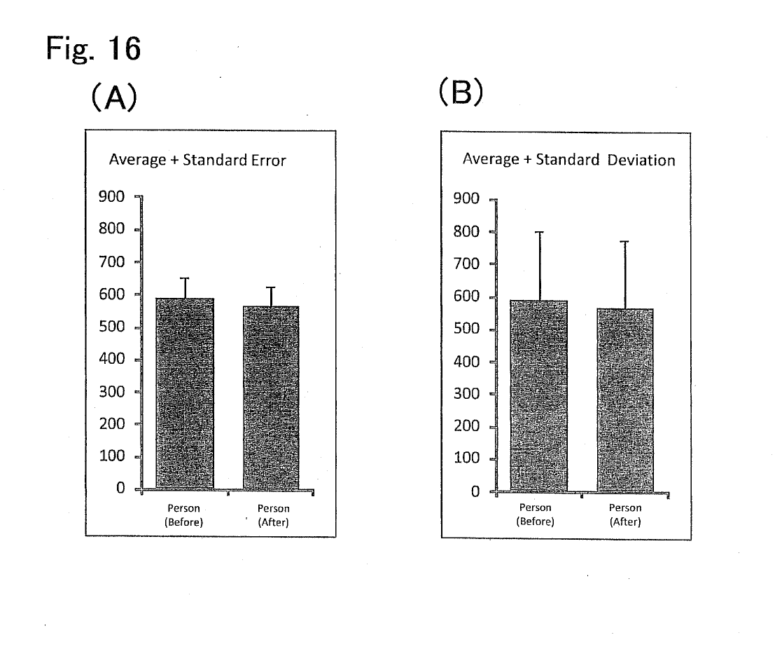

The scoring result of the pre-training test and the post-training test with respect to the model image of “person” in the group (a) which did not perform training at all is shown in FIG. 16. FIG. 16 (A) shows an average and a standard error, wherein the average before the training was 592.000, the standard error before the training was 60.531, the average after the training was 567.000, and the standard error after the training was 60.579. FIG. 16 (B) shows the average and a standard deviation, wherein the average before the training was 592.000, the standard deviation before the training was 209.684, the average after the training was 567.000, and the standard deviation after the training was 209.851.

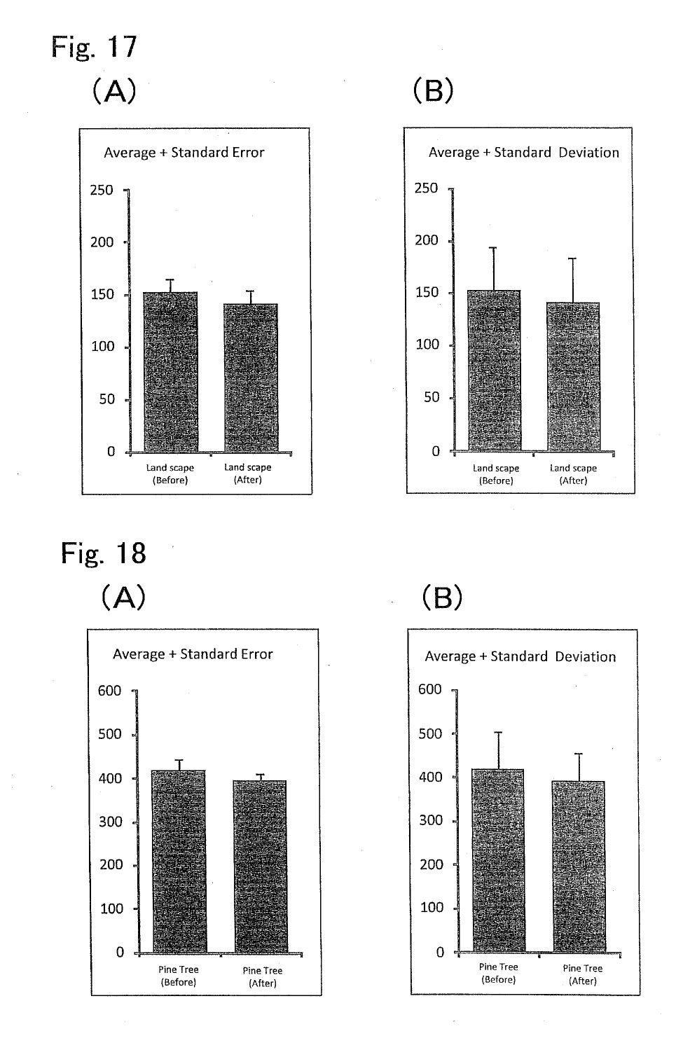

The scoring result of the pre-training test and the post-training test with respect to the model image of “land scape” in the group (b) which trained by the grid method is shown in FIG. 17. FIG. 17 (A) shows an average and a standard error, wherein the average before the training was 153.083, the standard error before the training was 11.768, the average after the training was 141.833, and the standard error after the training was 12.308. FIG. 17 (B) shows the average and a standard deviation, wherein the average before the training was 153.083, the standard deviation before the training was 40.764, the average after the training was 141.833, and the standard deviation after the training was 42.636.

The scoring result of the pre-training test and the post-training test with respect to the model image of “pine tree” in the group (b) which trained by the grid method is shown in FIG. 18. FIG. 18 (A) shows an average and a standard error, wherein the average before the training was 419.500, the standard error before the training was 24.932, the average after the training was 394.667, and the standard error after the training was 17.696. FIG. 18 (B) shows the average and a standard deviation, wherein the average before the training was 419.500, the standard deviation before the training was 86.367, the average after the training was 394.667, and the standard deviation after the training was 61.300.

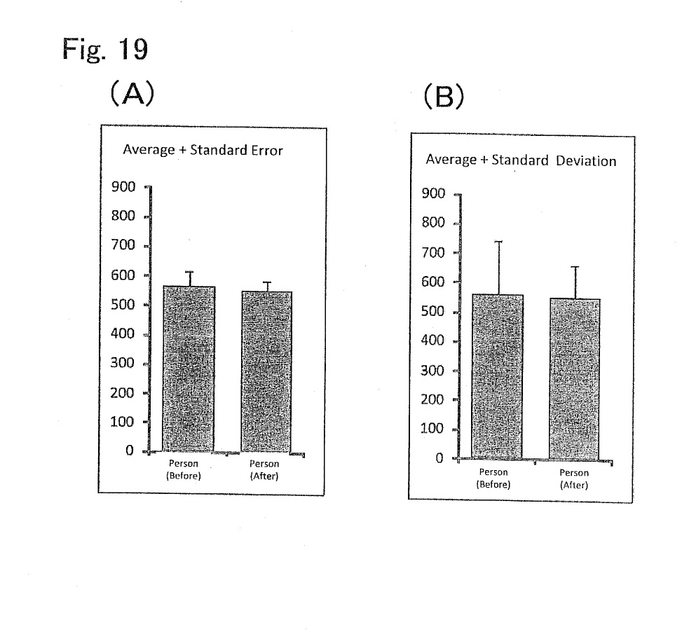

The scoring result of the pre-training test and the post-training test with respect to the model image of “person” in the group (b) which trained by the grid method is shown in FIG. 19. FIG. 19 (A) shows an average and a standard error, wherein the average before the training was 565.583, the standard error before the training was 51.658, the average after the training was 553.417, and the standard error after the training was 31.834. FIG. 19 (B) shows the average and a standard deviation, wherein the average before the training was 565.583, the standard deviation before the training was 178.949, the average after the training was 553.417, and the standard deviation after the training was 110.275.

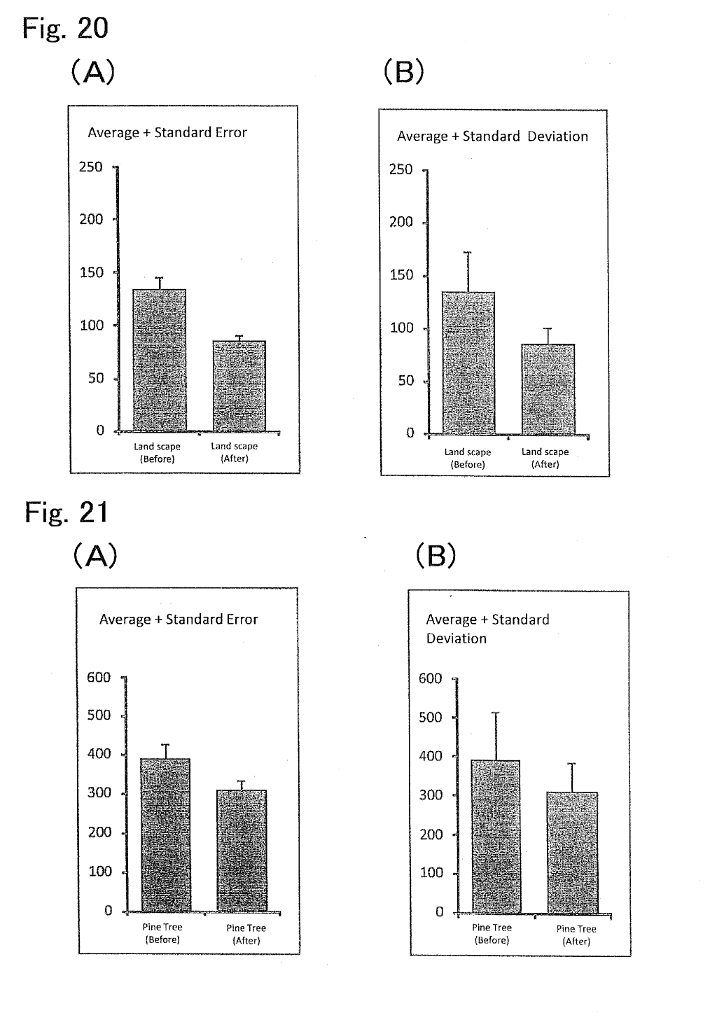

The scoring result of the pre-training test and the post-training test with respect to the model image of “land scape” in the group (c) which trained using the capacity building system according to this embodiment is shown in FIG. 20. FIG. 20 (A) shows an average and a standard error, wherein the average before the training was 135.417, the standard error before the training was 10.665, the average after the training was 86.583, and the standard error after the training was 4.456. FIG. 20 (B) shows the average and a standard deviation, wherein the average before the training was 135.417, the standard deviation before the training was 36.943, the average after the training was 86.583, and the standard deviation after the training was 15.436.

The scoring result of the pre-training test and the post-training test with respect to the model image of “pine tree” in the group (c) which trained using the capacity building system according to this embodiment is shown in FIG. 21. FIG. 21 (A) shows an average and a standard error, wherein the average before the training was 392.917, the standard error before the training was 35.123, the average after the training was 312.167, and the standard error after the training was 20.854. FIG. 21 (B) shows the average and a standard deviation, wherein the average before the training was 392.917, the standard deviation before the training was 121.670, the average after the training was 312.167, and the standard deviation after the training was 72.241.

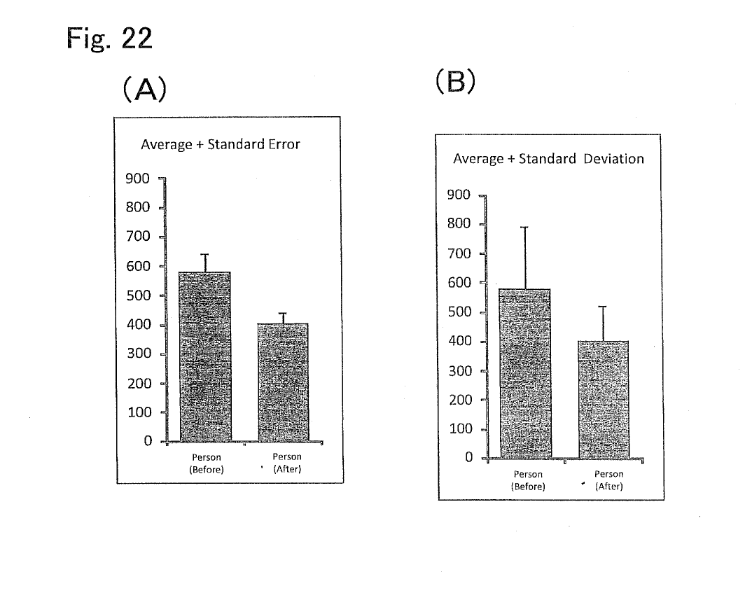

The scoring result of the pre-training test and the post-training test with respect to the model image of “person” in the group (c) which trained using the capacity building system according to this embodiment is shown in FIG. 22. FIG. 22 (A) shows an average and a standard error, wherein the average before the training was 579.917, the standard error before the training was 61.276, the average after the training was 405.167, and the standard error after the training was 34.540. FIG. 22 (B) shows the average and a standard deviation, wherein the average before the training was 579.917, the standard deviation before the training was 212.268, the average after the training was 405.167, and the standard deviation after the training was 119.651.

As will be apparent from the comparison of each of FIGS. 14, 17 and 20, from the comparison of each of FIGS. 15, 18 and 21, and from the comparison of each of FIGS. 16, 19 and 22, the group (c) which trained using the capacity building system according to this embodiment could provide large differences in value between the pre-training and the post-training, and large learning effect with respect to any of the model images of “land scape”, “pine tree” and “person”.

Many widely different embodiments of the present invention may be constructed without departing from the spirit and scope of the present invention. It should be understood that the present invention is not limited to the specific embodiments described in the specification, except as defined in the appended claims.

1. A capacity building system for developing visual-spatial construction planning ability, including a display section capable of displaying a model image containing mainly oblique lines and non-right angle cross lines in a model image area and an exercise image formed by a learner in an exercise image area, respectively, an input section capable of inputting contents to be displayed on said display section, a memory section preliminarily storing a plurality of model images, and an arithmetic section electrically connected to said display section, said input section and said memory section,
said arithmetic section comprising:
a model image display means for displaying a model image to be copied and a model image reference of said model image to be copied, in said model image area of said display section, said model image and said model image reference being selected and read out from a plurality of model images stored in said memory section;
a model image marks-entering request means for requesting the learner to enter marks on edges, cross points, top points and/or positions with a large inclination of the model image displayed by said model image display means;
a model image auxiliary lines-entering request means for requesting the learner to enter a plurality of vertical auxiliary lines and a plurality of horizontal auxiliary lines in said model image area so that each vertical auxiliary line and each horizontal auxiliary line pass through at least one mark entered by the learner;
an exercise image auxiliary line-entering request means for requesting the learner to enter a plurality of vertical auxiliary lines and a plurality of horizontal auxiliary lines in said exercise image area based upon an exercise image reference displayed in said exercise image area and provided with a scale size different from that of said model image reference, said plurality of vertical auxiliary lines and said plurality of horizontal auxiliary lines entered in said exercise image corresponding to the plurality of vertical auxiliary lines and the plurality of horizontal auxiliary lines of said model image;
an exercise image marks-entering request means for requesting the learner to enter marks on positions, in the exercise image area, corresponding to the marks of said model image, said positions being on the plurality of vertical auxiliary lines and the plurality of horizontal auxiliary lines in said exercise image area, entered by the learner; and
an exercise image forming request means for requesting the learner to form the exercise image by connecting between the marks in said exercise image area entered by the learner with lines.

2. The capacity building system as claimed in claim 1, wherein said exercise image auxiliary line-entering request means comprises:
a length determination request means for requesting the learner to determine lengths of vertical and horizontal auxiliary lines based upon said exercise image reference and to enter at least one vertical auxiliary line and at least one horizontal auxiliary line;
an outer frame-entering request means for requesting the learner to enter an outer frame of the exercise image based upon the lengths determined; and
an auxiliary lines-additionally entering request means for requesting the learner to additionally enter vertical and horizontal auxiliary lines necessary within the outer frame entered.

3. The capacity building system as claimed in claim 1, wherein said arithmetic section further comprises an error check means for informing an occurrence of error when an error occurred in the vertical and horizontal auxiliary lines entered by the learner in the exercise image area is equal to or larger than a predetermined value.

4. The capacity building system as claimed in claim 1, wherein said model image reference is defined by a plurality of model image reference points and wherein said exercise image reference is defined by a plurality of exercise image reference points having a distance there between, which is different from that of the plurality of model image reference points.

5. The capacity building system as claimed in claim 1, wherein said arithmetic section further comprises a scoring means for detecting an error between said model image and the exercise image formed to score the exercise image.

6. The capacity building system as claimed in claim 5, wherein said scoring means comprises an error detection means for superimposing the model image on the exercise image after adjusting the scale size of the model image with the exercise image reference, and for detecting a sum of distance differences between edges, cross points, top points or positions with a large inclination of the exercise image formed and corresponding edges, cross points, top points or positions with a large inclination of the model image superimposed.

7. A capacity building method for developing visual-spatial construction planning ability by a computer which includes a display section capable of displaying a model image containing mainly oblique lines and non-right angle cross lines in a model image area and an exercise image formed by a learner in an exercise image area, respectively, an input section capable of inputting contents to be displayed on said display section, a memory section preliminarily storing a plurality of model images, and an arithmetic section electrically connected to said display section, said input section and said memory section,
said method comprising:
a model image display step of displaying a model image to be copied and a model image reference of said model image to be copied, in said model image area of said display section, said model image and said model image reference being selected and read out from a plurality of model images stored in said memory section;
a model image marks-entering request step of requesting the learner to enter marks on edges, cross points, top points and/or positions with a large inclination of the model image displayed by said model image display step;
a model image auxiliary lines-entering request step of requesting the learner to enter a plurality of vertical auxiliary lines and a plurality of horizontal auxiliary lines in said model image area so that each vertical auxiliary line and each horizontal auxiliary line pass through at least one mark entered by the learner;
an exercise image auxiliary line-entering request step of requesting the learner to enter a plurality of vertical auxiliary lines and a plurality of horizontal auxiliary lines in said exercise image area based upon an exercise image reference displayed in said exercise image area and provided with a scale size different from that of said model image reference, said plurality of vertical auxiliary lines and said plurality of horizontal auxiliary lines entered in said exercise image corresponding to the plurality of vertical auxiliary lines and the plurality of horizontal auxiliary lines of said model image;
an exercise image marks-entering request step of requesting the learner to enter marks on positions, in the exercise image area, corresponding to the marks of said model image, said positions being on the plurality of vertical auxiliary lines and the plurality of horizontal auxiliary lines in said exercise image area, entered by the learner; and
an exercise image forming request step of requesting the learner to form the exercise image by connecting between the marks in said exercise image area entered by the learner with lines.

8. The ability development method as claimed in claim 7, wherein said exercise image auxiliary line-entering request step comprises:
a length determination request step of requesting the learner to determine lengths of vertical and horizontal auxiliary lines based upon said exercise image reference and to enter at least one vertical auxiliary line and at least one horizontal auxiliary line;
an outer frame-entering request step of requesting the learner to enter an outer frame of the exercise image based upon the lengths determined; and
an auxiliary lines-additionally entering request step of requesting the learner to additionally enter vertical and horizontal auxiliary lines necessary within the outer frame entered.

9. The ability development method as claimed in claim 7, wherein said method further comprises an error check step of informing an occurrence of error when an error occurred in the vertical and horizontal auxiliary lines entered by the learner in the exercise image area is equal to or larger than a predetermined value.

10. The ability development method as claimed in claim 7, wherein said model image reference is defined by a plurality of model image reference points and wherein said exercise image reference is defined by a plurality of exercise image reference points having a distance there between, which is different from that of the plurality of model image reference points.

11. The ability development method as claimed in claim 7, wherein said method further comprises a scoring step of detecting an error between said model image and the exercise image formed to score the exercise image.

12. The ability development method as claimed in claim 11, wherein said scoring step comprises an error detection step of superimposing the model image on the exercise image after adjusting the scale size of the model image with the exercise image reference, and of detecting a sum of distance differences between edges, cross points, top points or positions with a large inclination of the exercise image formed and corresponding edges, cross points, top points or positions with a large inclination of the model image superimposed.

13. A capacity building program product for developing visual-spatial construction planning ability, said program product being stored in a computer which includes a display section capable of displaying a model image containing mainly oblique lines and non-right angle cross lines in a model image area and an exercise image formed by a learner in an exercise image area, respectively, an input section capable of inputting contents to be displayed on said display section, a memory section preliminarily storing a plurality of model images, and an arithmetic section electrically connected to said display section, said input section and said memory section,
said arithmetic section comprising:
a model image display means for displaying a model image to be copied and a model image reference of said model image to be copied, in said model image area of said display section, said model image and said model image reference being selected and read out from a plurality of model images stored in said memory section;
a model image marks-entering request means for requesting the learner to enter marks on edges, cross points, top points and/or positions with a large inclination of the model image displayed by said model image display means;
a model image auxiliary lines-entering request means for requesting the learner to enter a plurality of vertical auxiliary lines and a plurality of horizontal auxiliary lines in said model image area so that each vertical auxiliary line and each horizontal auxiliary line pass through at least one mark entered by the learner;
an exercise image auxiliary line-entering request means for requesting the learner to enter a plurality of vertical auxiliary lines and a plurality of horizontal auxiliary lines in said exercise image area based upon an exercise image reference displayed in said exercise image area and provided with a scale size different from that of said model image reference, said plurality of vertical auxiliary lines and said plurality of horizontal auxiliary lines entered in said exercise image corresponding to the plurality of vertical auxiliary lines and the plurality of horizontal auxiliary lines of said model image;
an exercise image marks-entering request means for requesting the learner to enter marks on positions, in the exercise image area, corresponding to the marks of said model image, said positions being on the plurality of vertical auxiliary lines and the plurality of horizontal auxiliary lines in said exercise image area, entered by the learner; and
an exercise image forming request means for requesting the learner to form the exercise image by connecting between the marks in said exercise image area entered by the learner with lines.

14. A computer readable recording medium in which a capacity building program for developing visual-spatial construction planning ability is stored, said program being used in a computer which includes a display section capable of displaying a model image containing mainly oblique lines and non-right angle cross lines in a model image area and an exercise image formed by a learner in an exercise image area, respectively, an input section capable of inputting contents to be displayed on said display section, a memory section preliminarily storing a plurality of model images, and an arithmetic section electrically connected to said display section, said input section and said memory section,
said arithmetic section comprising:
a model image display means for displaying a model image to be copied and a model image reference of said model image to be copied, in said model image area of said display section, said model image and said model image reference being selected and read out from a plurality of model images stored in said memory section;
a model image marks-entering request means for requesting the learner to enter marks on edges, cross points, top points and/or positions with a large inclination of the model image displayed by said model image display means;
a model image auxiliary lines-entering request means for requesting the learner to enter a plurality of vertical auxiliary lines and a plurality of horizontal auxiliary lines in said model image area so that each vertical auxiliary line and each horizontal auxiliary line pass through at least one mark entered by the learner;
an exercise image auxiliary line-entering request means for requesting the learner to enter a plurality of vertical auxiliary lines and a plurality of horizontal auxiliary lines in said exercise image area based upon an exercise image reference displayed in said exercise image area and provided with a scale size different from that of said model image reference, said plurality of vertical auxiliary lines and said plurality of horizontal auxiliary lines entered in said exercise image corresponding to the plurality of vertical auxiliary lines and the plurality of horizontal auxiliary lines of said model image;
an exercise image marks-entering request means for requesting the learner to enter marks on positions, in the exercise image area, corresponding to the marks of said model image, said positions being on the plurality of vertical auxiliary lines and the plurality of horizontal auxiliary lines in said exercise image area, entered by the learner; and
an exercise image forming request means for requesting the learner to form the exercise image by connecting between the marks in said exercise image area entered by the learner with lines.
